(19) United States
(12) Patent Application Publication
(10) Pub. No.: US 2016/0363879 A1
(43) Pub. Date: Dec. 15, 2016

(54) TONER

(71) Applicant: CANON KABUSHIKI KAISHA, Tokyo (JP)

(72) Inventors: Akira Tsuboyama, Machida-shi (JP); Akiko Kitao, Kawasaki-shi (JP); Takeshi Sekiguchi, Kawasaki-shi (JP)

(21) Appl. No.: 15/177,230

(22) Filed: Jun. 8, 2016

(30) Foreign Application Priority Data
Jun. 11, 2015 (JP) 2015-118574

(51) Int. Cl. G03G 9/09

(52) U.S. Cl. CPC G03G 9/0924

(57) ABSTRACT

This invention provides a toner excellent in color development properties. The purpose can be achieved by using a toner containing a compound having a specific structure.

### BACKGROUND OF THE INVENTION

Field of the Invention

The present invention relates to a toner for use in recording methods, such as an electrophotography, an electrostatic recording method, a magnetic recording method, and a toner jet method.

Description of the Related Art

In recent years, color images have become increasingly widespread and a demand for an increase in image quality has increased. In digital full color copying machines or printers, a color image original is subjected to color separation with color filters of blue, green, and red, and then a latent image corresponding to the original image is developed using developing agents of respective colors of yellow, magenta, cyan, and black. Therefore, the coloring strength of a coloring agent in the developing agent of each color has had great influence on the image quality.

Moreover, the reproducibility of color space, such as Japan Color in the print industry and AdobeRGB in DeskTop Publishing (DTP), is important. For the reproducibility of the color space, not only an improvement of the dispersibility of pigments but methods using dyes having a large color gamut are known.

The coloring strength of coloring agents, such as the pigments and the dyes mentioned above, is dependent on the color development properties of the coloring agents.

For example, the outline of boron complex compounds is described in Chemical Review 2007, 107, 4891-4932.

### SUMMARY OF THE INVENTION

The present inventions provides a toner capable of reproducing a large color gamut.

The toner is obtained by the invention described below.

More specifically, the present invention is a toner containing a binding resin and a coloring agent, in which the coloring agent contains at least one compound selected from the group consisting of a compound represented by the following general formula (1) and a compound represented by the following general formula (2),

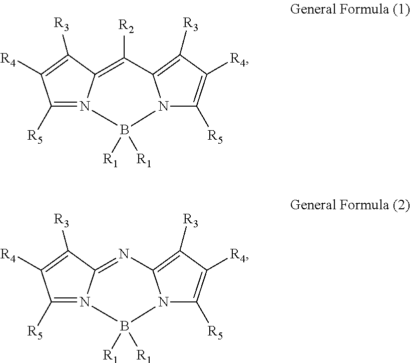

in which, R₁ represents a halogen atom, an alkyl group, an alkynyl group, an alkoxy group, an aryl group, or a phenoxy group, or represents an atomic group necessary for forming a ring structure by bonding with adjacent R₅, R₂ represents a hydrogen atom, a halogen atom, a cyano group, an alkyl group, an aryl group, a phenoxy group, a thiophenoxy group, an alkynyl group, or an amino group, R₃ represents a hydrogen atom, an alkyl group, or an aryl group, or represents an atomic group necessary for forming a ring structure by bonding with adjacent R₄, R₄ represents a hydrogen atom, an alkyl group, an aryl group, an alkyl acrylate group, or a sulfone group, or represents an atomic group necessary for forming a ring structure by bonding with adjacent R₃ or R₅, and R₅ represents a hydrogen atom, an alkyl group, an aryl group, or an alkynyl group, or represents an atomic group necessary for forming a ring structure by bonding with adjacent R₁ or R₄.

R₃ and R₄, R₄ and R₅, and R₁ and R₅, which are adjacent to each other, may be bonded to each other to form a ring structure.

Further features of the present invention will become apparent from the following description of exemplary embodiments with reference to the attached drawing.

### BRIEF DESCRIPTION OF THE DRAWINGS

FIGS. 1A and 1B are views showing the color saturation and the brightness (C*, L*) in the L*a*b* color system.

### DESCRIPTION OF THE EMBODIMENTS

The present invention is described below in detail.

The present inventors have conducted extensive researches in order to solve the above-described problems, and, as a result, have found that the color reproduction range of a toner can be enlarged by the use of a compound having a structure represented by the following general formula (1) or the following general formula (2) as a coloring agent.

When the compound having the structure represented by the following general formula (1) or the following general formula (2) is used in combination with other former coloring agents, the color coordinate values can be more greatly changed and a larger color reproduction region can be realized as compared with the case where two kinds of former coloring agents are used in combination.

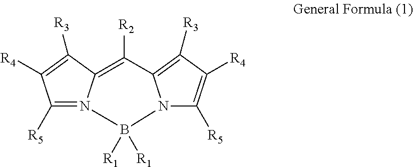

in which, in General Formula (1),
R₁ represents a halogen atom, an alkyl group, an alkynyl group having a substituent, an alkoxy group, an aryl group, an aryl group having a substituent, or a phenoxy group, or represents an atomic group necessary for forming a ring structure by bonding with adjacent R₅,
R₂ represents a hydrogen atom, a halogen atom, a cyano group, an alkyl group, an aryl group, a phenoxy group, a thiophenoxy group, an alkynyl group, or an amino group,
R₃ represents a hydrogen atom, an alkyl group, or an aryl group, or represents an atomic group necessary for forming a ring structure by bonding with adjacent R₄,
R₄ represents a hydrogen atom, an alkyl group, an aryl group, an alkyl acrylate group, or a sulfone group, or represents an atomic group necessary for forming a ring structure by bonding with adjacent R₃ or R₅, and
R₅ represents a hydrogen atom, an alkyl group, an aryl group, or an alkynyl group, or represents an atomic group necessary for forming a ring structure by bonding with adjacent R₁ or R₄,

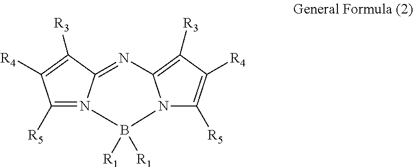

in which, R₁ and R₃ to R₅ in General Formula (2) represent the same substances as those in R₁ and R₃ to R₅ in General Formula (1).

First, the compound represented by General Formula (1) and the compound represented by General Formula (2) are described.

Examples of the halogen atoms in R₁ and R₂ in General Formula (1) and R₁ in General Formula (2) include a fluorine atom, a chlorine atom, a bromine atom, and an iodine atom.

Examples of the alkyl groups in R₁ to R₅ in General Formula (1) and R₁ and R₃ to R₅ in General Formula (2) include, but are not particularly limited thereto, straight, branched, or cyclic primary to tertiary alkyl groups having 1 to 10 carbon atoms, such as a methyl group, an ethyl group, an n-propyl group, an iso-propyl group, an n-butyl group, a sec-butyl group, a tert-butyl group, an octyl group, a cyclopentyl group, a cyclohexyl group, a methylcyclohexyl group, a 2-ethylpropyl group, and a 2-ethylhexyl group, for example.

Examples of the aryl groups in R₁ to R₅ in General Formula (1) and R₁ and R₃ to R₅ in General Formula (2) include, but are not particularly limited thereto, a phenyl group, a naphthyl group, and the like, for example. These groups may have an alkyl group, a fluoride alkyl group, and an amino group as substituents. Specifically, a methyl phenyl group, a dimethyl phenyl group, a trimethyl phenyl group, an amino phenyl group, a trifluoromethyl phenyl group, a tert-butyl-phenyl group, and the like are mentioned.

Examples of the alkynyl groups in R₁, R₂, and R₅ in General Formula (1) and in R₁ and R₅ in General Formula (2) include an ethynyl group. The alkynyl group may have a phenyl group, a methylphenyl group, an anthracenyl group, a silyl group, and a trimethylsilyl group as substituents. For example, a phenyl ethynyl group, a methyl phenyl ethynyl group, a trimethyl silylethynyl group, an anthracenyl ethynyl group, and the like are mentioned.

Examples of the alkoxy groups in R₁s in General Formula (1) and in General Formula (2) include, but are not particularly limited thereto, a methoxy group, an ethoxy group, a propoxy group, a butoxy group, and the like, for example.

As examples in which R₁ and R₅ which are adjacent to each other in General Formula (1) and General Formula (2) are bonded to each other to form a ring structure, structures in which a phenoxy ring substituted by R₅ is bonded to boron as in exemplary compounds 604 and 807 shown later are mentioned. The ring structure may have a substituted group.

As examples in which R₃ and R₄ or R₄ and R₅ which are adjacent to each other in General Formula (1) and General Formula (2) are bonded to each other to form a ring structure, a benzene ring, a thiophen ring, a furan ring, a cyclopentane ring, and a cyclohexane ring are mentioned. The ring structure may have a substituted group.

Examples of the alkyl acrylate groups (—C═CH(COOR)) in R₄s in General Formula (1) and General Formula (2) include, but are not particularly limited thereto, a methyl acrylate group, an ethyl acrylate group, a butyl acrylate group, and the like, for example.

R₁s in General Formula (1) and General Formula (2) are suitably fluorine atoms from the viewpoint of ease of synthesis and stability of the compounds.

Moreover, the compounds represented by General Formula (1) are more suitable from the viewpoint of ease of synthesis of the compounds and an improvement of the color gamut.

The compounds represented by General Formula (1) or General Formula (2) can be synthesized referring to known methods and the like described in the following literatures, for example.
Chemical Review 2007, 107, 4891-4932
Journal of Organic Chemistry 2012, 77, 669-673
Organic Letters 2012, 14, 6150-6153
Organic Letters 2008, 10, 4771-4774

Suitable examples of the compounds represented by General Formula (1) or General Formula (2) are shown below but are not particularly limited to the following compound examples.

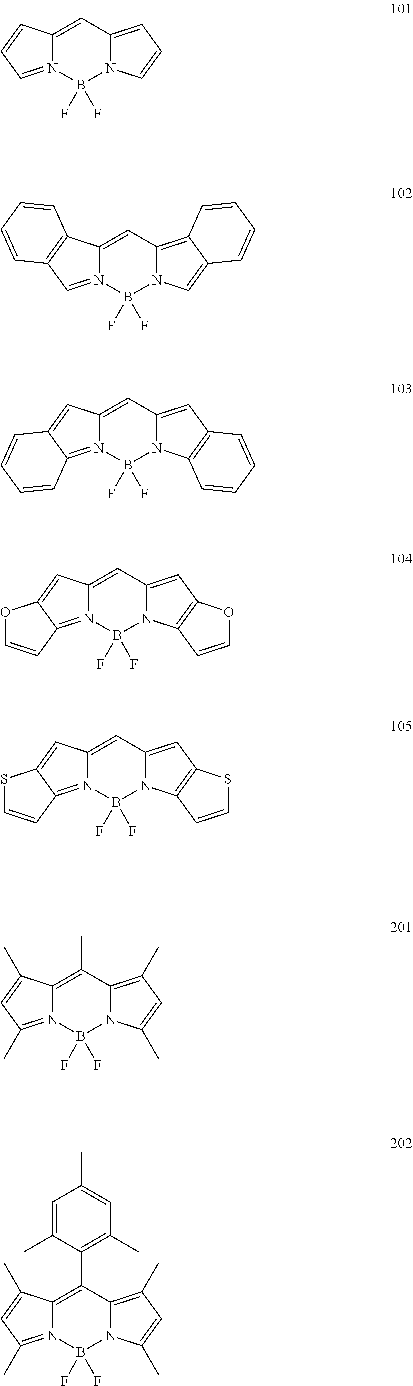

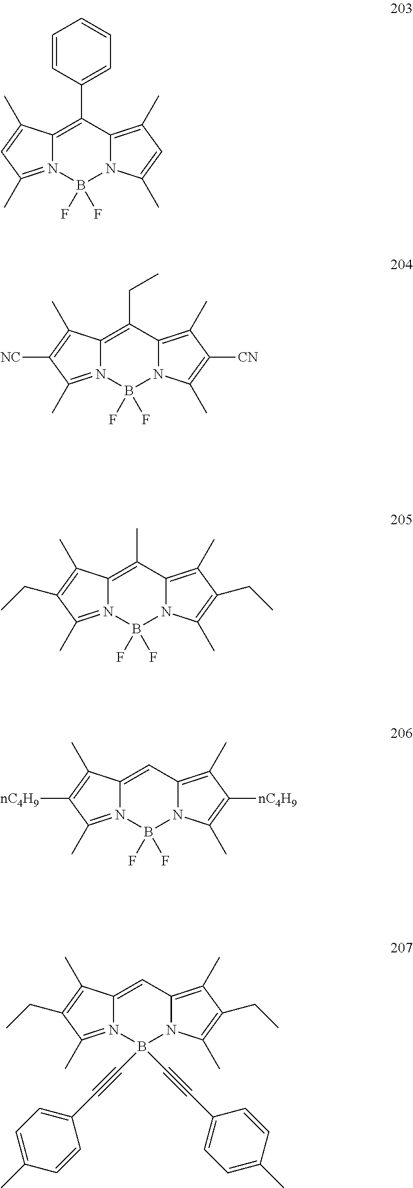

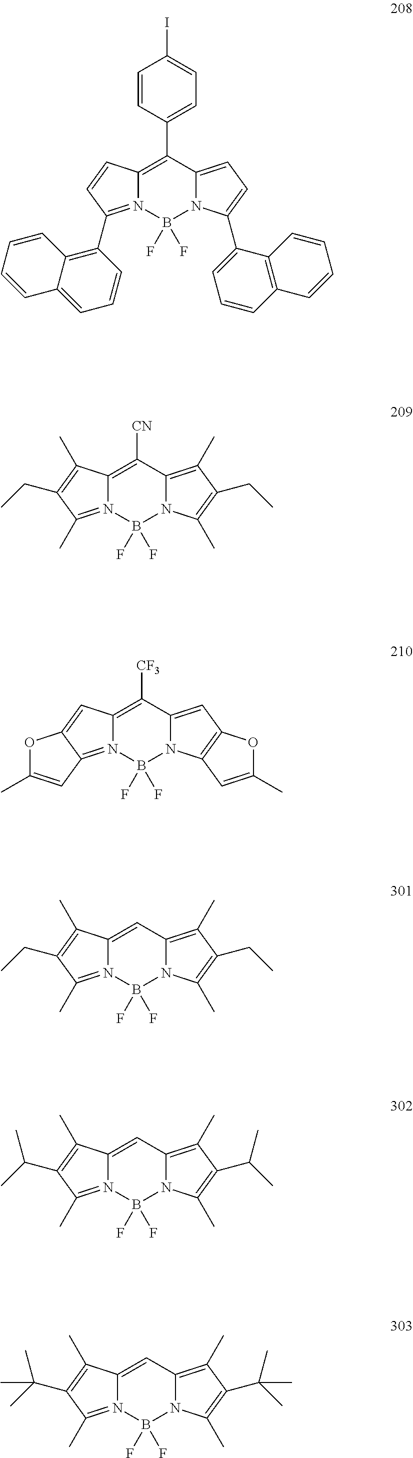

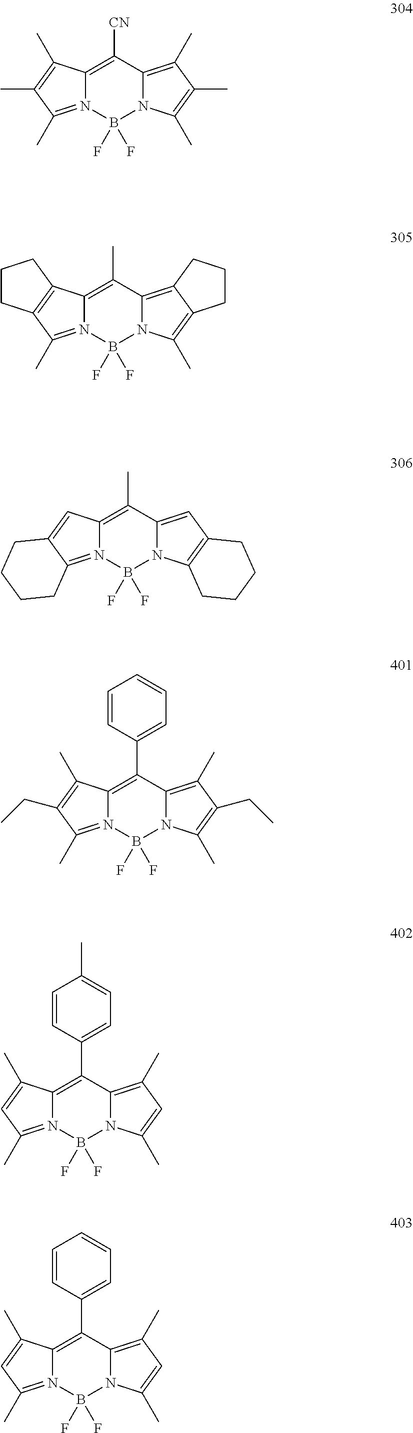

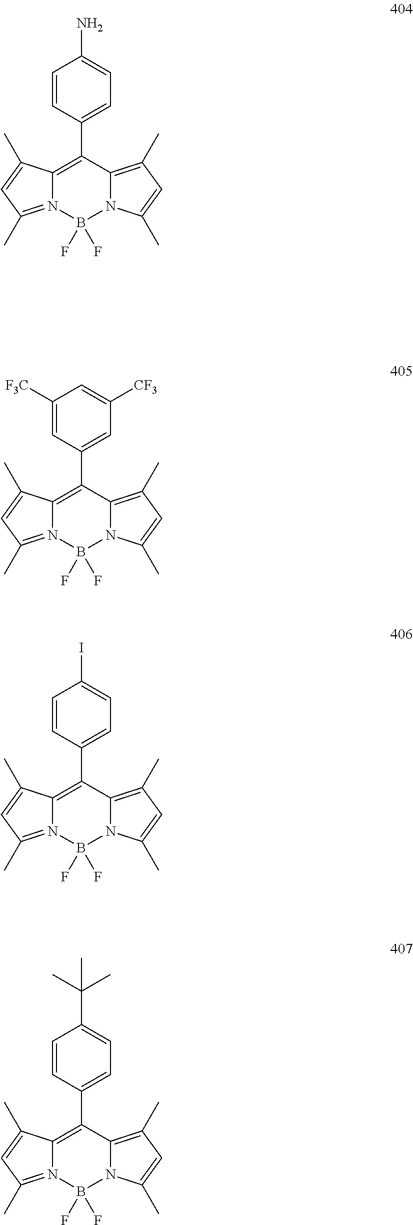

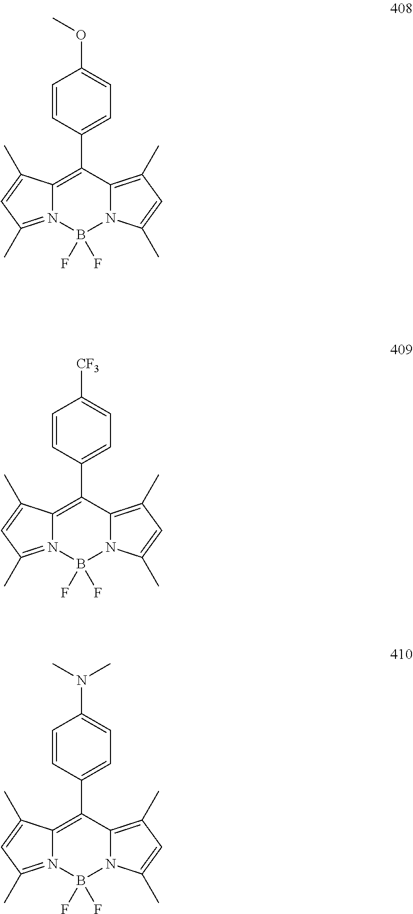

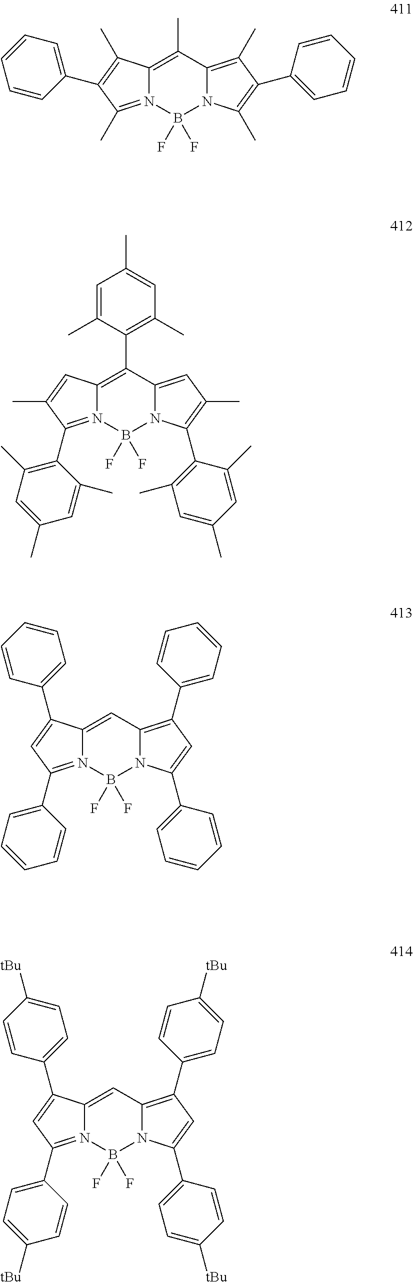

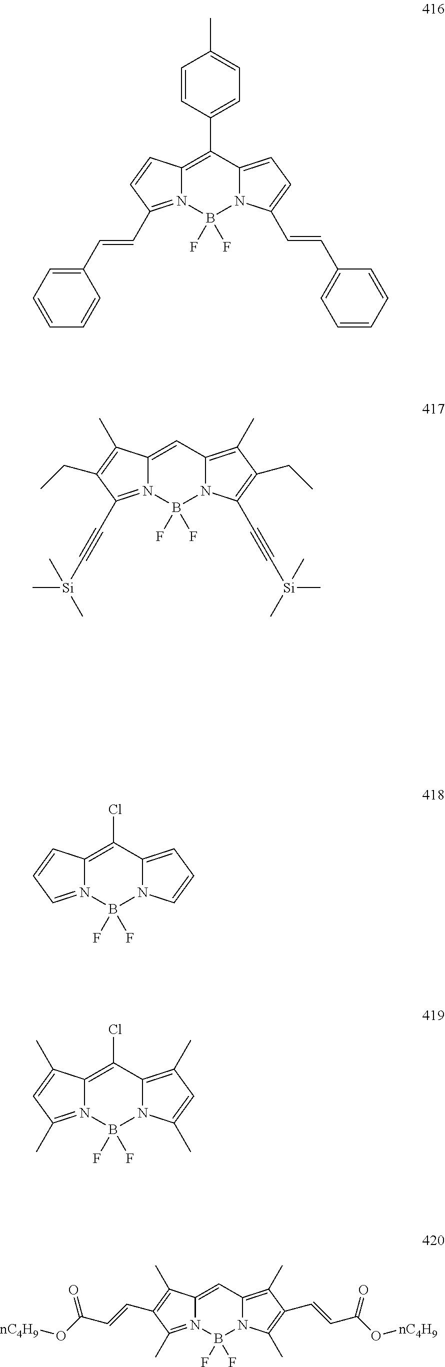

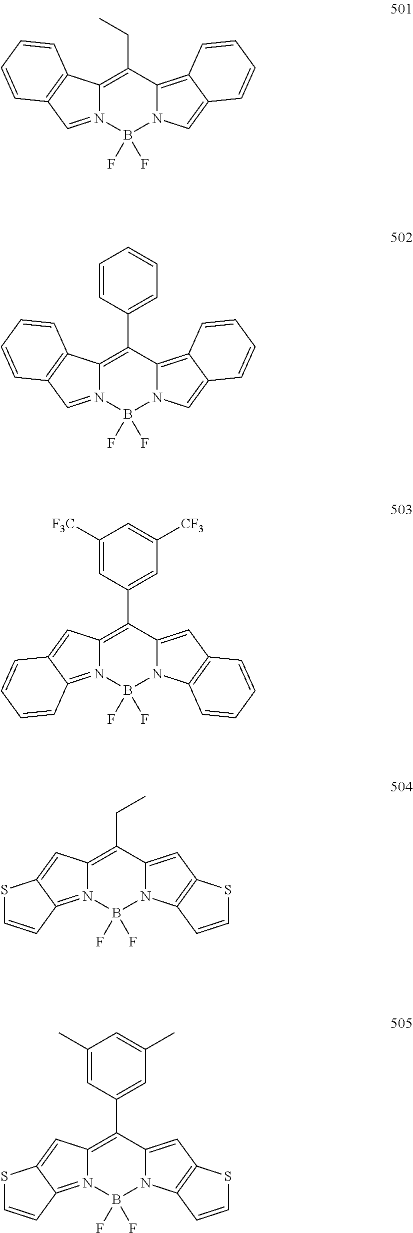

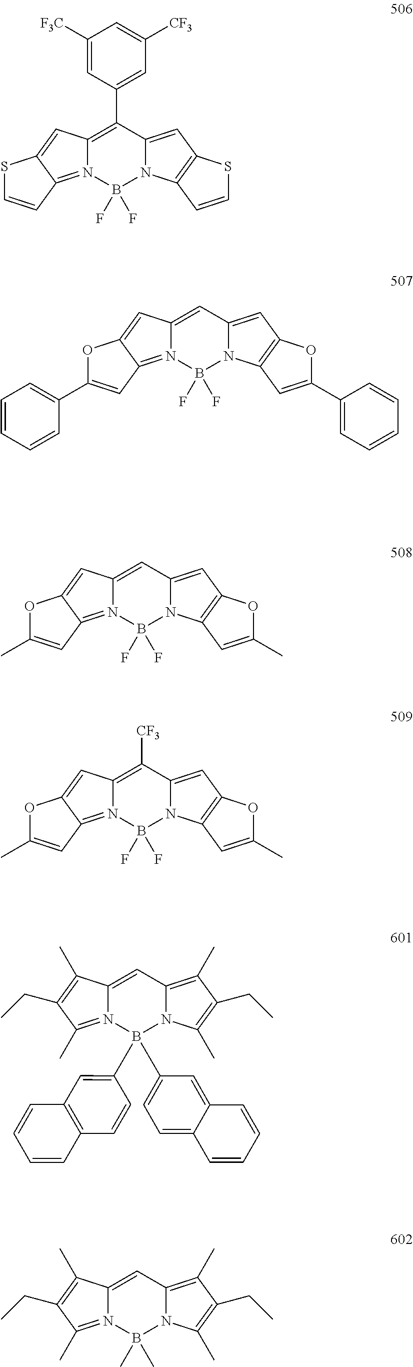

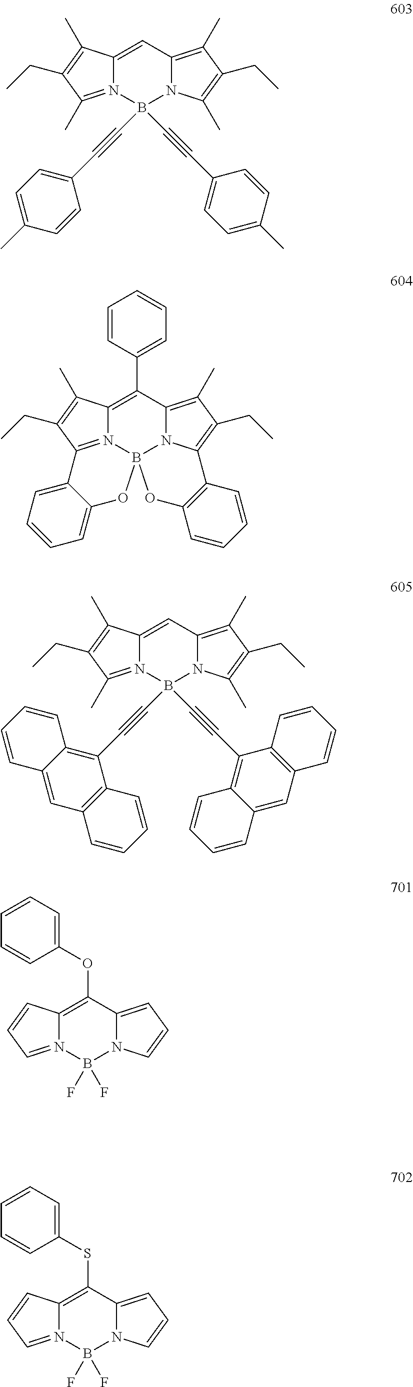

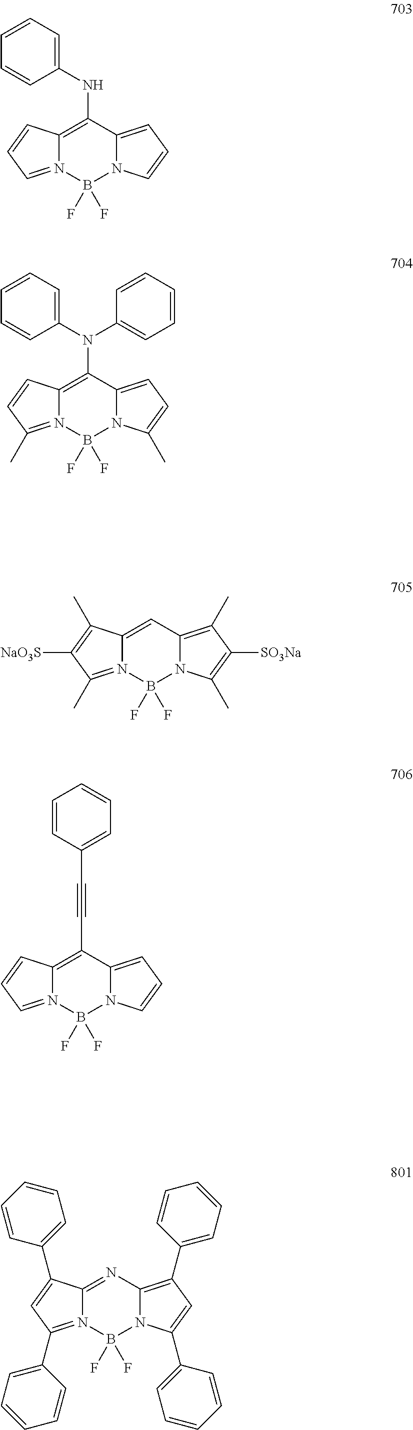

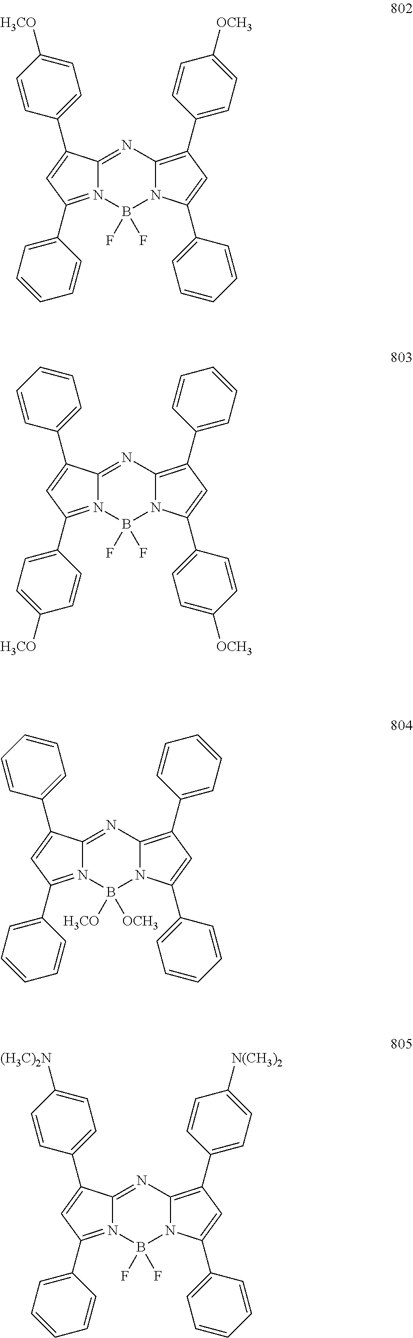

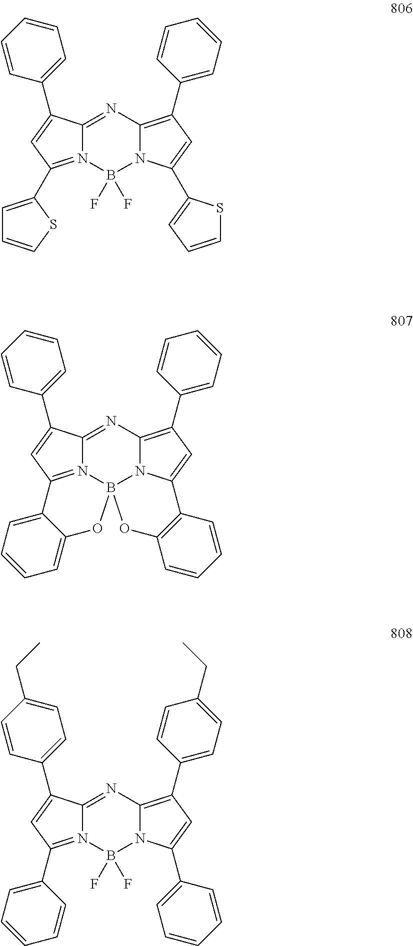

By blending the compounds of General Formula (1) or General Formula (2) in a toner, the color reproduction range can be enlarged. When the compounds of General Formula (1) or General Formula (2) and former coloring agents are used in combination, the color coordinate can be greatly changed with respect to the color coordinates of former coloring agents alone. By mixing the compounds of General Formula (1) or General Formula (2) with coloring agents of the same type of colors, the coloring strength can be compensated and the color reproduction range can be enlarged.

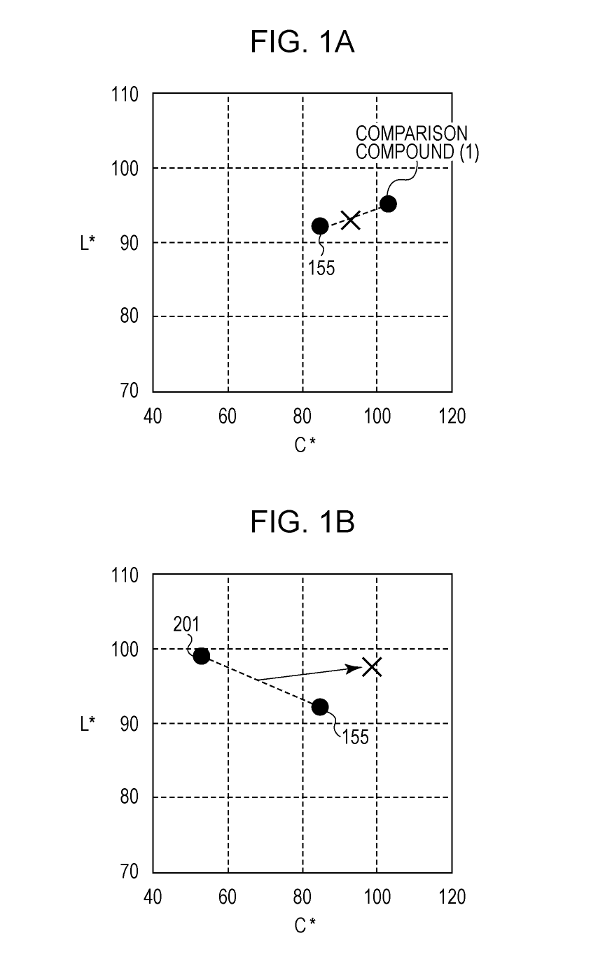

The description above is explained with reference to FIGS. 1A and 1B as an example. FIG. 1A shows the color saturation and the brightness (C*, L*) in the L*a*b* color system on the coordinate when former coloring agents are individually used alone or in combination. marks represent the color coordinates when a pigment yellow 155 (PY155) and a comparison compound (1) shown later are individually used alone. x marks represents the color coordinate when the PY155 and the comparison compound (1) are mixed for use.

In this experiment, when the coloring agent is used alone, the ratio of the coloring agent to a binder resin is 5 parts of the coloring agent based on 100 parts of the binder resin. When the comparison compound (1) and the PY155 are mixed, the total amount of the coloring agents is 5 parts and the ratio of the comparison compound (1) to PY155 is 1 part:4 parts.

### Comparison Compound (1):

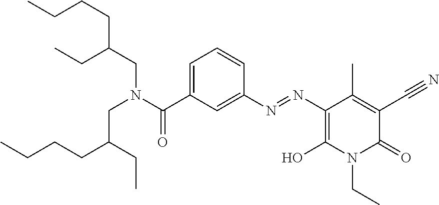 [SMILES: CCCCC(CC)CN(CC(CC)CCCC)C(=O)c1cccc(/N=N/c2c(C)c(C#N)c(=O)n(CC)c2O)c1]

As is clear from FIG. 1A, when the mixture of the PY155 and the comparison compound (1) is used, the chromaticity coordinate is the interpolation point between the chromaticity coordinate when the PY155 is used alone and the chromaticity coordinate when the comparison compound (1) is used alone. As illustrated in FIG. 1A, the (C*, L*) value (x mark in FIG. 1A) when the PY155 and the comparison compound (1) are mixed to be used as the coloring agent is (C*, L*)=(91.3, 92.5).

When the compounds represented by General Formula (1) or General Formula (2) are used, the change manners of the color coordinates greatly vary. In FIG. 1B, marks represent cases where a yellow type compound 201 represented by General Formula (1) and the PY155 are individually used alone. x mark represents a case where the compound 201 and the PY155 are used in combination (Parts of the compound 201 to the PY155 based on 100 parts of a binder resin: 1 part:4 parts). Unlike the case of FIG. 1A, it is found that the position of the chromaticity coordinate when the compound 201 and the PY155 are mixed for use is considerably different from the interpolation point when the compound 201 and the PY155 are individually used alone. As illustrated in FIG. 1B, the (C*, L*) value (x mark in FIG. 1B) when the compound 201 and the PY155 are mixed to be used as the coloring agent is (C*, L*)=(98.2, 97.0). It is found that the color saturation and brightness values in the case of using the compound 201 are higher than the values in the case of using the mixture of former coloring agents. More specifically, the color reproduction range can be enlarged.

The compounds represented by General Formula (1) or General Formula (2) to be used in the present invention do not necessarily need to be used in combination with other coloring agents in one toner. For example, a toner manufactured using the compounds represented by General Formula (1) or General Formula (2) and a toner manufactured using the other coloring agents are mixed. Then, the mixed toner can be introduced into a cartridge to be used for printing. Images can be separately formed using the two kinds of toners above on a medium, such as paper, and then the colors can be mixed on the medium. In any case, the same effects as those described with reference to FIGS. 1A and 1B are obtained.

Among the compounds above, those to be used as a yellow coloring agent are the compounds 101, 201 to 207, 301 to 303, 305 to 306, 401 to 412, 414, 417 to 419, 602 to 603, and 701 to 706. These compounds can be mixed with already-existing yellow coloring agents for use.

The compounds to be used as a magenta coloring agent are the compounds 102 to 105, 208 to 210, 304, 413, 416, 420, 501 to 509, 601, 604 to 605, and 801 to 808. These compounds can be mixed with already-existing magenta coloring agents for use.

Next, the toner of the present invention is described.

### About Binding Resin

A binding resin to be used in the toner of the present invention is not particularly limited insofar as the resin is known as a binding resin for toner.

Specific examples of the resin include vinyl-based polymers obtained by polymerizing styrene-based monomers, such as styrene, p-chlorostyrene, and α-methylstyrene; acrylic acid ester-based monomers or methacrylic acid ester-based monomers, such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; vinyl nitrile-based monomers, such as acrylonitrile and methacrylonitrile; vinyl ether-based monomers, such as vinyl ethyl ether and vinyl isobutyl ether; vinyl ketone-based monomers, such as vinyl methyl ketone, vinyl ethyl ketone, and vinyl isopropenyl ketone, and the like; homopolymers or copolymers (olefin-based resin) of olefins, such as ethylene, propylene, butadiene, and isoprene; non-vinyl condensation resin, such as epoxy resin, polyester resin, polyurethane resin, polyamide resin, cellulose resin, and polyether resin, and graft polymers of the non-vinyl condensation resin and the vinyl-based monomers. These kinds of resin may be used alone or in combination of two or more kinds thereof.

The polyester resin is one of suitable resin. The polyester resin is synthesized from acid components (for example, dicarboxylic acid) and alcohol components (for example, diol).

Examples of the acid components include, but are not particularly limited thereto, aliphatic dicarboxylic acids, dicarboxylic acids having a double bond, and dicarboxylic acids having a sulfonic acid group. Specific examples of the acid components include oxalic acid, malonic acid, succinic acid, glutaric acid, adipic acid, pimelic acid, suberic acid, azelaic acid, sebacic acid, 1,9-nonane dicarboxylic acid, 1,10-decane dicarboxylic acid, 1,11-undecane dicarboxylic acid, 1,12-dodecane dicarboxylic acid, 1,13-tridecane dicarboxylic acid, 1,14-tetradecane dicarboxylic acid, 1,16-hexadecane dicarboxylic acid, 1,18-octadecane dicarboxylic acid, and lower alkyl esters and acid anhydrides thereof. The aliphatic dicarboxylic acids are particularly suitable and saturated aliphatic dicarboxylic acids are more suitable.

On the other hand, the alcohol components are not particularly limited and aliphatic diols are suitable. For example, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-dodecanediol, 1,12-undecanediol, 1,13-tridecanediol, 1,14-tetradecanediol, 1,18-octadecanediol, and 1,20-eicosanediol are mentioned.

In the present invention, in order to increase the mechanical strength of toner particles and control the molecular weight of toner molecules, a crosslinking agent can also be used during the synthesis of the binding resin.

Examples of the crosslinking agent to be used in the toner of the present invention include, but are not particularly limited thereto, bifunctional crosslinking agents including divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycols #200, #400, and #600, dipropylene glycol diacrylate, polypropylene glycol diacrylate, polyester type diacrylate, and those obtained by replacing the diacrylate with dimethacrylates, for example.

Examples of multifunctional crosslinking agents include, but are not particularly limited thereto, pentaerythritol triacrylate, trimethylolethane triacrylate, trimethylolpropane triacrylate, tetramethylolmethane tetraacrylate, oligoester acrylate, and methacrylate thereof, 2,2-bis(4-methacryloxyphenyl)propane, diallyl phthalate, triallyl cyanurate, triallyl isocyanurate, and triallyl trimellitate, for example.

The content of the crosslinking agent is preferably 0.05 to 10% by mass and more preferably 0.1 to 5% by mass based on the mass of the binding resin in the respect of the fixability and the offset resistance of the toner.

### About Wax

Wax refers to a material to be used in order to prevent the offset in toner fixing.

Wax components which can be used in the present invention are not particularly limited. Specific examples of the wax components include petroleum-based wax, such as paraffin wax, microcrystalline wax, and petrolatum, montan wax and derivatives thereof, hydrocarbon wax obtained by a Fischer-Tropsch process and a derivative thereof, polyolefin wax typified by polyethylene and a derivative thereof, and natural wax, such as carnauba wax and candelilla wax and derivatives thereof. The derivatives include oxides, block copolymers with vinyl monomers, and graft-modified products. Moreover, alcohols, such as higher aliphatic alcohols, aliphatic acids, such as stearic acid and pulmitic acid or compounds, acid amides, esters, and ketones thereof, hydrogenated castor oil and a derivative thereof, vegetable wax, and animal wax. These substances can be used alone or in combination.

Wax having a melting point of 50° C. or more and 200° C. or less is suitable and wax having a melting point of 55° C. or more and 150° C. or less is more suitable.

The melting point indicates the endothermic main peak temperature on the differential scanning calorimeter (DSC) curve measured according to ASTM D3418-82.

Specifically, the melting point of the wax is the endothermic main peak temperature on the DSC curve obtained during a second temperature rise process under the conditions of a measurement temperature range of 30 to 200° C. and a temperature rise rate of 5° C./min using a differential scanning calorimeter (manufactured by Mettler-Toledo: DSC822). The measurement is performed in a normal temperature and normal humidity environment.

With respect to the addition amount of the wax, the total content of the wax based on 100 parts by mass of the binding resin is preferably within the range of 2.5 to 15 parts by mass and more preferably within the range of 3.0 to 10 parts by mass.

### About Coloring Agent

In the toner of the present invention, the compounds represented by General Formula (1) or General Formula (2) may be used alone or two or more kinds of the compounds represented by General Formula (1) or General Formula (2) may be used in combination. Moreover, other coloring agents can be used in combination as necessary. When two or more kinds of the compounds of General Formula (1) or General Formula (2) and other coloring agents are mixed for use, coloring agents of the same type of colors or different colors, such as yellow and magenta, may be mixed in order to achieve desired color development.

By the use of the compounds of the present invention in combination with the former coloring agents, the compounds of the present invention can further improve the color development properties and can further enlarge the color gamut than the former coloring agents. The following methods can be considered as methods for using the compounds of the present invention in combination with the former coloring agents:

(1) Using a toner in which the former coloring agent and the compound of the present invention are added at a fixed amount ratio;
(2) Manufacturing a toner in which the former coloring agent is added alone and a toner in which the compound of the present invention is added alone, and then mixing the two kinds of toners at a fixed amount ratio; and
(3) Manufacturing a toner in which the former coloring agent is added alone and a toner in which the compound of the present invention is added alone, separately forming an image on a medium using each toner, and then mixing the colors on the medium.

Examples of the other coloring agents which can be used in combination as a magenta type coloring compound include, but are not particularly limited thereto, condensed azo compounds, azo metal complexes, diketopyrrolopyrrole compounds, anthraquinone compounds, quinacridone compounds, base dye lake compounds, naphthol compounds, benzimidazolone compounds, thioindigo compounds, perylene compounds, methine compound, and allyl amide compounds.

More specifically, the following coloring agents can be used in combination.

Mentioned are C.I. Pigment Orange 1, 5, 13, 15, 16, 34, 36, 38, 62, 64, 67, 72, and 74; C.I. Pigment Red 2, 3, 4, 5, 6, 7, 12, 16, 17, 23, 31, 32, 41, 48, 48:1, 48:2, 48:3, 48:4, 53:1, 57:1, 81:1, 112, 122, 123, 130, 144, 146, 149, 150, 166, 168, 169, 170, 176, 177, 178, 179, 181, 184, 185, 187, 190, 194, 202, 206, 208, 209, 210, 220, 221, 224, 238, 242, 245, 253, 254, 255, 258, 266, 269, and 282; C.I. Pigment Violet 13, 19, 25, 32, and 50; and C.I. Solvent Red 19, 23, 24, 26, 42, 49, 135, and 164; and various coloring agent classified as derivatives thereof.

Among the above, it is more suitable to use C.I. Pigment Red 57:1, C.I. Pigment Red 122, and C.I. Pigment Red 150 which are color pigments excellent in color development properties and productivity as coloring agents for toner.

Examples of yellow type coloring agents which can be used in combination include, but are not particularly limited thereto, condensed azo compounds, azo metal complexes, diketopyrrolopyrrole compounds, anthraquinone compounds, quinacridone compounds, base dye lake compounds, naphthol compounds, benzimidazolone compounds, thioindigo compounds, perylene compounds, methine compound, and allyl amide compounds, for example.

Specific examples of the yellow type coloring agents include C.I. Solvent Yellow 1, 19, 44, 49, 62, 74, 77, 79, 81, 82, 83, 89, 90, 93, 98, 103, 104, 112, 120, 121, 151, 153, 154, and 162; C.I. Pigment Yellow 1, 2, 3, 4, 5, 6, 7, 10, 11, 12, 13, 14, 15, 17, 23, 62, 65, 73, 74, 81, 83, 93, 94, 95, 97, 98, 109, 110, 111, 117, 120, 127, 128, 129, 137, 138, 139, 147, 150, 151, 154, 155, 167, 168, 173, 174, 176, 180, 181, 183, 185, and 191; and various coloring agents classified as derivatives thereof.

Among the above, it is more suitable to use C.I. Pigment Yellow 74, 155, 180, 181, 183, and 185 which are color pigments excellent in color development properties and productivity as coloring agents for toner and particularly suitable to use C.I. Pigment Yellow 74, 155, 180, and 185.

The content of the compounds represented by General Formula (1) or General Formula (2) (the total amount when a plurality of coloring compounds are used) is preferably 0.05 to 30 parts by mass based on 100 parts by mass of the binding resin. The content is more preferably 0.05 to 20 parts by mass and still more preferably 0.1 to 15 parts by mass. When the content is within the ranges mentioned above, the dispersibility of the coloring compounds is improved while obtaining sufficient coloring strength.

### About Charge Control Agent

In the toner of the present invention, a charge control agent can be sometimes mixed for use as necessary.

As the charge control agent, known charge control agents can be utilized and charge control agents which have high charge speed and which can stably maintain a fixed charge amount are suitable. Furthermore, when the toner is manufactured by a direct polymerization method, charge control agents which have low polymerization inhibiting properties and which are substantially free from solubilizable substances in aqueous dispersion media are particularly suitable.

Examples of the charge control agent include, for example, charge control agents which control a toner to be negatively charged, such as polymers or copolymers having a sulfonic acid group, a sulfonic acid salt group, or a sulfonic ester group, salicylic acid derivatives and metal complexes thereof, monoazo metallic compounds, acetyl acetone metallic compounds, aromatic oxycarboxylic acids, aromatic mono- and poly-carboxylic acids and metal salts, anhydrides, and esters thereof, phenol derivatives, such as bisphenol, urea derivatives, metal containing naphthoic acid-based compounds, boron compounds, quarternary ammonium salts, calixarene, and resin-based charge control agents.

Examples of charge control agents which control a toner to be positively charged include, for example, nigrosine, nigrosine-modified substances with fatty acid metal salts and the like, guanidine compounds, imidazole compounds, quarternary ammonium salts, such as tributylbenzylammonium-1-hydroxy-4-naphthosulfonate and tetrabutylammonium tetrafluoroborate, and onium salts, such as phosphonium salts which are analogues thereof, and lake pigments thereof, triphenylmethane dyes and lake pigments thereof (Mentioned as laking agents are phosphotungstic acid, phosphomolybdic acid, phosphotungsten molybdic acid, tannic acid, lauric acid, gallic acid, ferricyanide, ferrocyanide, and the like.), metal salts of higher fatty acids, diorganotin oxides, such as dibutyltin oxide, dioctyltin oxide, and dicyclohexyltin oxide, diorganotin borates, such as dibutyltin borate, dioctyltin borate, and dicyclohexyltin borate, and resin-based charge control agents. These charge control agents may be used alone or in combination of two or more kinds thereof.

### About Fluidizer

In the toner of the present invention, inorganic fine powder may be added as a fluidizer. As the inorganic fine powder, fine powder, such as silica, titanium oxide, alumina, multiple oxides thereof, and those obtained by surface treating the substances above, can be used.

### About Method for Manufacturing Toner

As a method for manufacturing the toner of the present invention, a pulverization method, a suspension polymerization method, a suspension granulation method, an emulsion polymerization method, an emulsion aggregation method, and the like which have been used heretofore are mentioned. From the viewpoint of the environmental load in manufacturing and the controllability of the particle diameter, it is suitable to obtain the toner particularly by manufacturing methods including performing granulation in an aqueous medium, such as a suspension polymerization method and a suspension granulation method.

### About Coloring Compound Dispersion

A coloring compound dispersion is described.

The coloring compound dispersion as used in the present invention refers to one in which the above-described coloring agent is dispersed in a dispersion medium.

The coloring compound dispersion is obtained as follows, for example.

The above-described coloring agent and, as necessary, resin are melted into a dispersion medium, and then sufficiently blended with the dispersion medium under stirring. Furthermore, by applying mechanical shearing force thereto by a dispersing machine, such as a ball mill, a paint shaker, a dissolver, an attritor, a sand mill, or a high speed mill, the coloring agent can be stably and finely dispersed in the form of uniform fine particles.

The dispersion medium refers to water, organic solvents, or mixtures thereof.

When water is used as the dispersion medium, the coloring agent can be dispersed in water using an emulsifier. Examples of the emulsifier include cationic surfactants, anionic surfactants, and nonionic surfactants, for example. Examples of the cationic surfactants include dodecyl ammonium chloride, dodecyl ammonium bromide, dodecyl trimethyl ammonium bromide, dodecyl pyridinium chloride, dodecyl pyridinium bromide, and hexadecyl trimethyl ammonium bromide. Examples of the anionic surfactants include fatty acid soap, such as sodium stearate and sodium dodecanoate, dodecyl sodium sulfate, dodecyl benzene sodium sulfate, and sodium lauryl sulfate. Examples of the nonionic surfactants include dodecyl polyoxyethylene ether, hexadecyl polyoxyethylene ether, nonylphenyl polyoxyethylene ether, lauryl polyoxyethylene ether, sorbitan monooleate polyoxyethylene ether, and monodecanoyl sucrose.

Examples of the organic solvents which can be used as the dispersion medium include, but are not particularly limited thereto, alcohols, such as methyl alcohol, ethyl alcohol, denatured ethyl alcohol, isopropyl alcohol, n-butyl alcohol, isobutyl alcohol, tert-butyl alcohol, sec-butyl alcohol, tert-amyl alcohol, 3-pentanol, octyl alcohol, benzyl alcohol, and cyclohexanol; glycols, such as methyl cellosolve, ethyl cellosolve, diethylene glycol, and diethylene glycol monobutyl ether; ketones, such as acetone, methyl ethyl ketone, and methyl isobutyl ketone; esters, such as ethyl acetate, butyl acetate, ethyl propionate, and cellosolve acetate; hydrocarbon-based solvents, such as hexane, octane, petroleum ether, cyclohexane, benzene, toluene, and xylene; halogenated hydrocarbon solvents, such as carbon tetrachloride, trichloroethylene, and tetrabromoethane; ethers, such as diethylether, dimethyl glycol, trioxane, and tetrahydrofuran; acetals methylal and diethyl acetal; organic acids, such as formic acid, acetic acid, and propionic acid; sulfur.nitrogen containing organic compounds, such as nitrobenzene, dimethylamine, monoethanolamine, pyridine, dimethylsulfoxide, and dimethylformamide.

Moreover, polymerizable monomers can also be used as the dispersion medium. The polymerizable monomers are addition polymerizable or condensation polymerizable monomers and suitably addition polymerizable monomers. Specifically, styrene, styrene-based monomers, such as o-methylstyrene, m-methylstyrene, p-methylstyrene, o-ethylstyrene, m-ethylstyrene, and p-ethylstyrene; acrylate-based monomers, such as methyl acrylate, ethyl acrylate, propyl acrylate, butyl acrylate, octyl acrylate, dodecyl acrylate, stearyl acrylate, behenyl acrylate, 2-ethylhexyl acrylate, dimethylaminoethyl acrylate, diethylaminoethyl acrylate, acrylonitrile, and amide acrylate; methacrylate-based monomers, such as methyl methacrylate, ethyl methacrylate, propyl methacrylate, butyl methacrylate, octyl methacrylate, dodecyl methacrylate, stearyl methacrylate, behenyl methacrylate, 2-ethylhexyl methacrylate, dimethylaminoethyl methacrylate, diethylaminoethyl methacrylate, methacrylonitrile, and amide methacrylate; olefin-based monomers, such as ethylene, propylene, butylene, butadiene, isoprene, isobutylene, and cyclohexene; vinyl halides, such as vinyl chloride, vinylidene chloride, vinyl bromide, and vinyl iodide; vinyl esters, such as vinyl acetate, vinyl propionate, and vinyl benzoate; vinyl ethers, such as vinyl methyl ether, vinyl ethyl ether, and vinyl isobutyl ether; and vinyl ketone compounds, such as vinyl methyl ketone, vinyl hexyl ketone, and methyl isopropenyl ketone can be mentioned. These substances may be used alone or in combination of two or more kinds thereof according to the intended use. When a polymer toner is manufactured using the coloring compound dispersion of the present invention, it is suitable to use styrene or the styrene-based monomers, among the polymerizable monomers, alone or as a mixture with the other polymerizable monomers. From the viewpoint of ease of handling, styrene is particularly suitable.

As the resin which can be added to the coloring compound dispersion, resin which can be used as the binding resin of the toner of the present invention can be used. Specific examples of the resin include polystyrene resin, a styrene-methacrylic acid copolymer, a styrene-acrylic acid copolymer, an epoxy resin, a styrene-butadiene copolymer, polyacrylic resin, polymethacrylic acid resin, polyacrylic ester resin, polymethacrylic acid ester resin, an acrylic acid-based copolymer, a methacrylic acid-based copolymer, polyester resin, polyvinyl ether resin, polyvinyl methyl ether resin, polyvinyl alcohol resin, polyvinyl butyral resin, polyurethane resin, and polypeptide resin. The resin may be used alone or as a mixture of two or more kinds thereof.

The amount of the coloring agent in the dispersion medium in the coloring compound dispersion needs to be the following amount as the total amount in order to maintain the coloring properties even when one coloring agent is used alone or two or more kinds of coloring agents are used.

The amount of the coloring agent is preferably 1.0 to 30 parts based on 100 parts of the dispersion medium. The amount of the coloring agent is more preferably 2.0 to 20 parts and particularly preferably 3.0 to 15 parts. When the content of the coloring agent is within the ranges mentioned above, an increase in viscosity and a reduction in coloring agent dispersibility can be prevented, and good coloring strength can be demonstrated.

The coloring compound dispersion can be isolated by known methods, e.g., filtering, decantation, or centrifugal separation. The solvent can also be removed by washing.

In the coloring compound dispersion, assistants may be further added in the manufacturing. Specific examples of the assistants include, for example, surfactants, coloring compound and non-coloring compound dispersion stabilizers, fillers, standardizers, resin, wax, antifoaming agents, electrostatic prevention agents, dustproof agents, extenders, shading colorants, preservatives, dry inhibitors, rheology control additives, wetting agents, antioxidants, UV absorbents, photostabilizers, or combinations thereof.

By the use of the coloring compound dispersion, an increase in dispersion viscosity can be suppressed in the dispersion medium, which facilitates the handling in a toner manufacturing process. Furthermore, since good dispersibility of the coloring agent is maintained, a toner having high coloring strength is provided.

### Manufacturing of Toner by Suspension Polymerization Method

The toner of the present invention can be suitably manufactured by a suspension polymerization method.

First, a coloring agent containing the compound represented by General Formula (1) or General Formula (2), a polymerizable monomer, a wax component, a polymerization initiator, and the like are mixed to prepare a polymerizable monomer composition. Next, the polymerizable monomer composition is dispersed in an aqueous medium to granulate particles of the polymerizable monomer composition. Then, the polymerizable monomers in the polymerizable monomer composition particles are polymerized in an aqueous medium to obtain toner particles.

As the polymerization initiator for use in the suspension polymerization method, known polymerization initiators can be mentioned, and, for example, azo compounds, organic peroxides, inorganic peroxides, organic metallic compounds, and photopolymerization initiators are mentioned. More specifically, azo-based polymerization initiators, such as 2,2′-azobis(isobutyronitrile), 2,2′-azobis(2-methylbutyronitrile), 2,2′-azobis (4-methoxy-2,4-dimethylvaleronitrile), 2,2′-azobis(2,4-dimethylvaleronitrile), and dimethyl 2,2′-azobis(isobutyrate), organic peroxide-based polymerization initiators, such as benzoyl peroxide, ditert-butyl peroxide, tert-butyl peroxyisopropyl monocarbonate, tert-hexyl peroxy benzoate, and tert-butyl peroxy benzoate, inorganic peroxide-based polymerization initiators, such as potassium persulfate and ammonium persulfate, redox initiators, such as hydrogen peroxide-ferrous iron type, a BPO-dimethylaniline type, and a cerium (IV) salt-alcohol type, an acetophenone type, a benzoin ether type, and a ketal type are mentioned. These substances can be used alone or in combination of two or more kinds thereof.

The concentration of the polymerization initiator is preferably within the range of 0.1 to 20 parts by mass and more preferably within the range of 0.1 to 10 parts by mass based on 100 parts by mass of the polymerizable monomers. The polymerization initiator type slightly varies depending on polymerizing methods. The polymerization initiators are individually used alone or as a mixture referring to the 10-hour half-life temperature.

It is suitable to blend a dispersion stabilizer in the aqueous medium to be used in the suspension polymerization method. As the dispersion stabilizer, known inorganic and organic dispersion stabilizers can be used. Examples of the inorganic dispersion stabilizers include, for example, calcium phosphate, magnesium phosphate, aluminum phosphate, zinc phosphate, magnesium carbonate, calcium carbonate, calcium hydroxide, magnesium hydroxide, aluminum hydroxide, calcium metasilicate, calcium sulfate, barium sulfate, bentonite, silica, and aluminum. Examples of the organic dispersion stabilizers include polyvinyl alcohol, gelatin, methyl cellulose, methyl hydroxypropyl cellulose, ethyl cellulose, sodium salt of carboxymethylcellulose, and starch, for example. Moreover, nonionic, anionic, and cationic surfactants can also be used. For example, sodium dodecyl sulfate, sodium tetradecyl sulfate, sodium pentadecyl sulfate, sodium octyl sulfate, sodium oleate, sodium laurate, potassium stearate, and calcium oleate are mentioned.

Among the dispersion stabilizers mentioned above, it is suitable to use poor water-soluble inorganic dispersion stabilizers which are soluble in acids. It is suitable to use these dispersion stabilizers in such a manner that the proportion thereof is in the range of 0.2 to 2.0 parts by mass based on 100 parts by mass of the polymerizable monomers in terms of the stability of liquid droplets in the aqueous medium of the polymerizable monomer composition. It is suitable to prepare the aqueous medium using water in the range of 300 to 3000 parts by mass based on 100 parts by mass of the polymerizable monomer composition.

A commercially-available dispersion stabilizer may be used as it is. However, in order to obtain dispersion stabilizer particles having a fine uniform particle diameter, it is suitable to generate the dispersion stabilizer in water under high-speed stirring. For example, when calcium phosphate is used as the dispersion stabilizer, a suitable dispersion stabilizer can be obtained by mixing an aqueous sodium phosphate solution and an aqueous calcium chloride solution under high-speed stirring to form calcium phosphate fine particles.

### Manufacturing of Toner by Suspension Granulation Method

The toner of the present invention can be suitably obtained also by a suspension granulation method. Since the manufacturing process of the suspension granulation method does not include a heating process, compatibilization of resin and wax occurring when a low melting point wax is used can be suppressed and a reduction in the glass transition temperature of the toner resulting from the compatibilization can be prevented. In the suspension granulation method, a binding resin is selected from various kinds of binding resin and it is easy to use a polyester resin which is generally advantageous in fixability as the main component. Therefore, when manufacturing a toner of a resin composition to which the suspension polymerization method cannot be applied, the suspension granulation method is an advantageous manufacturing method.

The toner particles to be manufactured by the suspension granulation method described above are manufactured as follows, for example.

First, a coloring agent containing the compound represented by General Formula (1) or General Formula (2), a binding resin, a wax component, and the like are mixed in a solvent to prepare a solvent composition. Next, the solvent composition is dispersed in an aqueous medium to granulate particles of the solvent composition to obtain a toner particle suspension. Then, the obtained suspension is heated or decompressed to remove the solvent, whereby toner particle can be obtained.

Examples of the solvents usable in the suspension granulation method include, for example, hydrocarbons, such as toluene, xylene, and hexane, halogen-containing hydrocarbons, such as methylene chloride, chloroform, dichloroethane, trichloroethane, and carbon tetrachloride, alcohols, such as methanol, ethanol, butanol, and isopropyl alcohol, polyhydric alcohols, such as ethylene glycol, propylene glycol, diethylene glycol, and triethylene glycol, cellosolves, such as methyl cellosolve and ethyl cellosolve, ketones, such as acetone, methyl ethyl ketone, and methyl isobutyl ketone, ethers, such as benzyl alcohol ethyl ether, benzyl alcohol isopropyl ether, and tetrahydrofuran, and esters, such as methyl acetate, ethyl acetate, and butyl acetate. These substances can be used alone or as a mixture of two or more kinds thereof. Among the solvents mentioned above, in order to easily remove the solvent in the toner particle suspension, it is suitable to use a solvent whose boiling point is low and which can sufficiently dissolve the binding resin.

The use amount of the solvent is preferably in the range of 50 to 5000 parts by mass and more preferably 120 to 1000 parts by mass based on 100 parts by mass of the binding resin.

It is suitable for the aqueous medium to be used in the suspension granulation method to contain a dispersion stabilizer. As the dispersion stabilizer, known inorganic and organic dispersion stabilizers can be used. Examples of the inorganic dispersion stabilizers include, for example, calcium phosphate, calcium carbonate, aluminum hydroxide, calcium sulfate, and barium carbonate. Examples of the organic dispersion stabilizers include, for example, water-soluble polymers, such as polyvinyl alcohol, methyl cellulose, hydroxyethyl cellulose, ethyl cellulose, sodium salt of carboxymethyl cellulose, sodium polyacrylate, and sodium polymethacrylate, anionic surfactants, such as sodium dodecylbenzenesulfonate, sodium octadecyl sulfate, sodium oleate, sodium laurate, and potassium stearate, cationic surfactants, such as lauryl amine acetate, stearyl amine acetate, and lauryl trimethyl ammonium chloride, amphoteric ionic surfactants, such as lauryl dimethylamine oxide, and nonionic surfactants, such as polyoxyethylene alkyl ether, polyoxyethylene alkyl phenyl ether, and polyoxyethylene alkyl amine.

The use amount of the dispersion stabilizer is suitably in the range of 0.01 to 20 parts by mass based on 100 parts by mass of the binding resin in terms of the stability of liquid droplets in the aqueous medium of the solvent composition.

### Manufacturing of Toner by Pulverization Method

A toner by a pulverization method can be manufactured using manufacturing devices known to persons skilled in the art, such as a mixer, a thermal kneader, and a classifier.

First, a coloring agent containing the compound represented by General Formula (1) or General Formula (2) is mixed with a binding resin, a magnetic material, wax, a charge control agent, and other toner components, as necessary. These substances are sufficiently mixed by a mixer, such as a Henschel mixer or a ball mill. Next, the mixture is melted using a thermal kneader, such as a roll, a kneader, or an extruder. Furthermore, kneading is performed for compatibilization of the resins, and then wax and a magnetic material are dispersed in the resultant mixture. After solidification by cooling, pulverization and classification are performed, whereby the toner by the pulverization method of the present invention can be obtained.

Examples of the binding resin which can be used for the toner by the pulverization method of the present invention include, for example, vinyl-based resin, polyester-based resin, epoxy-based resin, polyurethane-based resin, polyvinyl butyral-based resin, terpene-based resin, phenol-based resin, aliphatic or alicyclic hydrocarbon-based resin, aromatic petroleum-based resin, rosin, and modified rosin. Among the above, the vinyl-based resin and the polyester-based resin are suitable from the viewpoint of chargeability and fixability. Particularly when the polyester-based resin is used, the effects of chargeability and fixability are increased, and thus the use of the polyester-based resin is more suitable.

The resins mentioned above may be used alone or in combination of two or more kinds thereof as necessary. When two or more kinds of resins are mixed for use, it is suitable to mix resins different in the molecular weight in order to control the viscoelastic property of the toner.

The glass transition temperature of the binding resin for use in the toner by the pulverization method is preferably 45 to 80° C. and more preferably 55 to 70° C. The number average molecular weight (Mn) thereof is suitably 2,500 to 50,000. The weight average molecular weight (Mw) thereof is suitably 10,000 to 1,000,000.

When the polyester-based resin is used as the binding resin, one in which the alcohol component/acid component ratio is 45/55 to 55/45 (mol ratio) in all the components is suitable but the ratio is not particularly limited. With an increase in the number of the terminal groups of the molecular chain of the polyester-based resin to be used in the present invention, the environmental dependency of the charging characteristics of the toner increases. Therefore, the acid value is preferably 90 mgKOH/g or less and more preferably 50 mgKOH/g or less. The hydroxyl group value is preferably 50 mgKOH/g or less and more preferably 30 mgKOH/g or less.

### Manufacturing of Toner by Emulsion Aggregation Method

Next, a manufacturing method of a toner by an emulsion aggregation method of the present invention is described. First, various kinds of dispersion liquid are prepared. In this process, a wax dispersion liquid, a resin particle dispersion liquid, a coloring agent particle dispersion liquid containing a coloring compound represented by General Formula (1) or General Formula (2), and other toner components may be mixed as necessary to prepare the various kinds of dispersion liquid. The toner by an emulsion aggregation method of the present invention can be obtained by a process (aggregation process) of aggregating a mixture of the various kinds of dispersion liquid to form aggregate particles, a process (fusion process) of heating and fusing the aggregate particles, a washing process, and a drying process.

The various kinds of dispersion liquid can be manufactured using dispersion stabilizers, such as surfactants.

Examples of the surfactants include water-soluble polymers, inorganic compounds, and ionic or nonionic surfactants. In particular, ionic surfactants having high dispersibility are suitable from the viewpoint of a problem with dispersibility, and anionic surfactants are more suitably used. Specific examples of the surfactants include, but are not limited thereto, water-soluble polymers, such as polyvinyl alcohol, methyl cellulose, carboxymethyl cellulose, and sodium polyacrylate; anionic surfactants, such as sodium dodecylbenzene sulfonate, sodium octadecyl sulfate, sodium oleate, sodium laurate, and potassium stearate; cationic surfactants, such as lauryl amine acetate and lauryl trimethyl ammonium chloride; amphoteric surfactants, such as lauryl dimethyl amine oxide; nonionic surfactants, such as polyoxyethylene alkyl ether, polyoxyethylene alkyl phenyl ether, and polyoxyethylene alkyl amine; and inorganic compounds, such as tricalcium phosphate, aluminum hydroxide, calcium sulfate, calcium carbonate, and barium carbonate. These surfactants may be used alone or in combination of two or more kinds thereof as necessary.

From the viewpoint of washability and surface active ability, the molecular weight of the surfactant is preferably 100 to 10,000 and more preferably 200 to 5,000.

The resin particle dispersion liquid to be used for the toner by the emulsion aggregation method of the present invention is obtained by dispersing resin particles in an aqueous medium. The aqueous medium refers to a medium containing water as the main component. Specific examples of the aqueous medium include water itself, one in which a pH adjuster is added to water, and one in which an organic solvent is added to water.

The resin configuring the resin particles contained in the resin particle dispersion liquid is not particularly limited insofar as the resin is suitable for the toner. The resin is suitably a thermoplastic binding resin having a glass transition temperature equal to or lower than the fixing temperature in an electrophotographic apparatus.

As specific examples of the resin, styrenes, such as styrene, parachloro styrene, and α-methylstyrene, homopolymers of vinyl group-based monomers, such as methyl acrylate, ethyl acrylate, n-propyl acrylate, lauryl acrylate, 2-ethylhexyl acrylate, methyl methacrylate, ethyl methacrylate, n-propyl methacrylate, lauryl methacrylate, 2-ethylhexyl methacrylate, acrylonitrile, and methacrylonitrile, vinyl ether-based monomers, such as vinyl methyl ether and vinyl isobutyl ether, vinyl ketone-based monomers, such as vinyl methyl ketone, vinyl ethyl ketone, and vinyl isopropenyl ketone, and polyolefin-based monomers, such as ethylene, propylene, and butadiene, or copolymers obtained by combining two or more kinds thereof or mixtures of the homopolymers and the copolymers and furthermore, epoxy resin, polyester resin, polyurethane resin, polyamide resin, cellulose resin, polyether resin, and the like, non-vinyl condensation type resin, mixtures of the resin and the vinyl-based resin, or graft polymers obtained by polymerizing vinyl-based monomers in the presence of the substances mentioned above can be mentioned. From the viewpoint of the fixability and the charging performance as a toner, polystyrene resin or polyester resin is particularly suitably used. These kinds of resin may be used alone or in combination of two or more kinds thereof.

The resin particle dispersion liquid is prepared by known methods. For example, a resin particle dispersion liquid containing resin particles containing vinyl-based monomers, particularly styrene-based monomers, as the constituent components, can be prepared by performing emulsion polymerization of the monomers using a surfactant and the like.

As methods for preparing other kinds of resin particle dispersion liquid (for example, polyester resin particle dispersion liquid), a method is mentioned which includes dispersing resin dissolved by a solvent in water by a dispersing machine, such as a homogenizer, together with an ionic surfactant and a polymer electrolyte. Thereafter, the solvent is evaporated, whereby a resin particle dispersion liquid can be prepared. Moreover, a resin particle dispersion liquid may be prepared by a method including adding a surfactant to resin, and then performing emulsion dispersion of the mixture in water by a dispersing machine, such as a homogenizer, a phase inversion emulsification method, and the like.

The median diameter on a volume basis of the resin particles in the resin particle dispersion liquid is preferably 0.005 to 1.0 μm and more preferably 0.01 to 0.4 μm. When the median diameter is larger than 1.0 μm, it becomes difficult to obtain toner particles having a weight average particle diameter of 3.0 to 7.5 μm, which is suitable as toner particles.

The average particle diameter of the resin particles can be measured using a dynamic light scattering method (DLS), a laser scattering method, a centrifugal sedimentation method, a field-flow fractionation method, an electrical sensing zone method, and the like, for example. The average particle diameter in the present invention means, unless otherwise particularly specified, a 50% cumulative particle diameter (D50) on a volume basis measured by a dynamic light scattering (DLS)/laser Doppler method at 20° C. and a solid content concentration of 0.01% by mass as described later.

The coloring agent particle dispersion liquid to be used for preparing the toner by the emulsion aggregation method can be manufactured by dispersing, in an aqueous medium, a coloring agent containing a coloring compound represented by General Formula (1) together with a dispersion stabilizer, such as a surfactant. The coloring agent particles can be dispersed by known methods, and, for example, a media type dispersing machine, such as a rotary shearing type homogenizer, a ball mill, a sand mill, or an attritor, or a high-pressure counter collision type dispersing machine can be suitably used.

The content of the coloring agent is suitably 1.0 to 20.0 parts by mass based on 100.0 parts by mass of resin.

The use amount of the surfactant to be used is 0.01 to 10.0 parts by mass and preferably 0.1 to 5.0 parts by mass based on 100 parts by mass of the coloring agent. In particular, it is suitable to use the surfactant in the range of 0.5 to 3.0 parts by mass because the removal of the surfactant in the toner particles is facilitated. As a result, the effects that the amount of the surfactant remaining in the obtained toner decreases, the image density of the toner is high, fogging is difficult to occur are obtained.

### Aggregation Process

A method for forming the aggregate particles is not particularly limited and a method including adding and mixing a pH adjuster, an aggregating agent, a stabilizer, and the like to/with the mixed liquid, and then applying a temperature, mechanical force (stirring), or the like as appropriate to the mixed liquid can be suitably mentioned as an example.

The pH adjuster is not particularly limited, and alkalis, such as ammonia and sodium hydroxide, and acids, such as nitric acid and citric acid, are mentioned.

The aggregating agent is not particularly limited, and inorganic metal salts, such as sodium chloride, magnesium carbonate, magnesium chloride, magnesium nitrate, magnesium sulfate, calcium chloride, and aluminum sulfate, and di- or more valent metal complexes are mentioned.

As the stabilizer, surfactants are mainly mentioned. The surfactants are not particularly limited, and examples of the surfactants include water-soluble polymers, such as polyvinyl alcohol, methyl cellulose, carboxymethyl cellulose, and sodium polyacrylate; anionic surfactants, such as sodium dodecylbenzene sulfonate, sodium octadecyl sulfate, sodium oleate, sodium laurate, and potassium stearate; cationic surfactants, such as lauryl amine acetate and lauryl trimethyl ammonium chloride; amphoteric surfactants, such as lauryl dimethyl amine oxide; nonionic surfactants, such as polyoxyethylene alkyl ether, polyoxyethylene alkyl phenyl ether, and polyoxyethylene alkyl amine; and inorganic compounds, such as tricalcium phosphate, aluminum hydroxide, calcium sulfate, calcium carbonate, and barium carbonate. These surfactants may be used alone or in combination of two or more kinds thereof as necessary.

The average particle diameter of the aggregate particles formed herein is not particularly limited and may be generally controlled to be the same as the average particle diameter of the toner particles to be obtained. The control can be easily performed by, for example, setting•changing as appropriate the temperature at which the aggregating agent and the like are added•mixed and the stirring and mixing conditions. Furthermore, in order to prevent the melt-adhesion between the toner particles, the pH adjuster, the surfactant, and the like mentioned above can be introduced as appropriate.

### Fusion Process

In the fusion process, the aggregate particles are fused by heating to thereby form toner particles. The heating temperature may fall in the range from the glass transition temperature (Tg) of the resin contained in the aggregate particles to the decomposition temperature of the resin. For example, under stirring in the same manner as in the aggregation process, the progress of the aggregation is stopped by adding the surfactant or adjusting the pH, and then the resultant aggregate particles are heated to a temperature equal to or higher than the glass transition temperature of the resin of the resin particles to thereby fuse and unite the aggregate particles. The heating time may be set in such a manner that the fusing is sufficiently performed. Specifically, the heating may be performed for about 10 minutes to 10 hours.

Furthermore, before or after the fusion process, a process of forming a core-shell structure by adding•mixing a fine particle dispersion liquid, in which fine particles are dispersed, for causing the fine particles to adhere to the aggregate particles (adhering process) can be further performed.

### Washing Process

In the emulsion aggregation method, the toner particles obtained after the fusion process are washed, filtered, and then dried under appropriate conditions to thereby obtain toner base particles. In this case, it is suitable to sufficiently wash the toner particles in order to secure sufficient charging characteristics and reliability as a toner.

A washing method is not limited, and for example, a suspension liquid containing the toner particles is filtered. Next, the obtained filtered substance is washed under stirring using distilled water, and then the resultant substance is filtered. From the viewpoint of the chargeability of the toner, the washing is repeated until the electric conductivity of the filtrate reaches 150 μS/cm or less.

Furthermore, to the surfaces of the obtained toner particles, inorganic particles, such as silica, alumina, titania, or calcium carbonate, or resin particles of vinyl resin, polyester resin, or silicone resin may be added in a dry state under application of shearing force. Such inorganic particles and resin particles function as external additives, such as a fluidity assistant and a cleaning assistant.

### Drying Process

For the drying, known methods, such as a general vibration type fluidized drying method, a spray drying method, a freeze drying method, and a flush jet method, can be utilized. The moisture content of the toner particles after the drying is preferably 1.5% by mass or less and more preferably 1.0% by mass or less.

### Physical Properties of Toner

The toner of the present invention suitably has a weight average particle diameter D4 of 4.0 to 9.0 μm and a ratio of the weight average particle diameter D4 to a number average particle diameter D1 (hereinafter referred to as the weight average particle diameter D4/Number average particle diameter D1 ratio or the D4/D1) of 1.35 or less. More preferably, the weight average particle diameter D4 is 4.9 to 7.5 μm and the D4/D1 is 1.30 or less.

As a method for adjusting the weight average particle diameter D4 and the number average particle diameter D1 of the toner varies dependent on the preparation method for toner base particles. For example, in the case of the suspension polymerization method, the particle diameters can be adjusted by controlling the concentration of a dispersion stabilizer to be used in the preparation of the aqueous medium and the reaction stirring speed or the reaction stirring time.

The toner of the present invention has average circularity, measured by a flow-type particle image analyzer, of preferably 0.930 to 0.995 and more preferably 0.960 to 0.990 from the viewpoint of the transferability of the toner.

The toner of the present invention may be either a magnetic toner or a non-magnetic toner. When the toner of the present invention is used as a magnetic toner, the toner particles configuring the toner of the present invention may contain a magnetic material. Examples of such a magnetic material include iron oxides, such as magnetite, maghemite, and ferrite, iron oxides containing other metal oxides, metals, such as Fe, Co, and Ni, and alloys of these metals and metals, such as Al, Co, Cu, Pb, Mg, Ni, Sn, Zn, Sb, Be, Bi, Cd, Ca, Mn, Se, Ti, W and V and mixtures thereof.

### Method for Manufacturing Liquid Developing Agent

The toner of the present invention can be used also for a developing agent (hereinafter referred to as a liquid developing agent) for use in a liquid development method. Hereinafter, a method for manufacturing a liquid developing agent is described.

First, a liquid developing agent is manufactured by dispersing or dissolving the coloring compound represented by General Formula (1) or General Formula (2) and resin and, as necessary, assistants, such as a charge control agent and wax, in an electrically insulating carrier liquid. Alternatively, a liquid developing agent may be manufactured by a two-step process including first preparing a concentrated toner, and then diluting the concentrated toner with an electrically insulating carrier liquid to prepare a developing agent.

A dispersing machine to be used in the present invention is not particularly limited, and a media type dispersing machine, such as a rotary shearing type homogenizer, a ball mill, a sand mill, or an attritor, or a high-pressure counter collision type dispersing machine can be suitably used.

To the coloring compound represented by General formula (1) or General Formula (2), one of or a combination of two or more kinds of coloring agents, such as known pigments and dyes, can be added for use.

The wax and the coloring agents for use in the present invention are the same as those described above.

The charge control agent for use in the present invention is not particularly limited insofar as the charge control agent is used in a liquid developing agent for electrostatic charge development. Examples of the charge control agent include cobalt naphthenate, copper naphthenate, copper oleate, cobalt oleate, zirconium octylate, cobalt octylate, sodium dodecylbenzene sulfonate, calcium dodecylbenzene sulfonate, soybean lecithin, and aluminum octoate.

The electrically insulating carrier liquid for use in the present invention is not particularly limited, and for example, an organic solvent having high electric resistance of 10⁹ Ω·cm or more and a low dielectric constant of 3 or less is suitably used. As specific examples, aliphatic hydrocarbon solvents, such as hexane, pentane, octane, nonane, decane, undecane, and dodecane, and solvents having a boiling point of 68 to 250° C., such as Isopar H, G, K, L and M (manufactured by Exxon Chemicals Ltd.) and Linealene Dimer A-20 and A-20H (manufactured by Idemitsu Kosan Co., Ltd.), are suitable. These substances may be used alone or in combination of two or more kinds thereof in the range where the viscosity of the styrene does not become high.

### EXAMPLES

The “part(s)” and “%” used in Examples described below are based on mass.

### Manufacturing of Toner

The toners of the present invention and comparative toners were manufactured by methods described below. Hereinafter, the manufacturing of toners of Examples and Comparative Examples are described one by one according to toner creation methods (Suspension polymerization method, Emulsion polymerization method, and Pulverization method).

The weight average particle diameter (D4) of each toner manufactured in each of Examples and Comparative Examples described below was 5.8 to 6.8 μm. The D4/D1 serving as the index of the particle diameter distribution was less than 1.35, which showed that the particle diameter distribution was good.

### Suspension Polymerization Method

### Example 1

A mixture of 0.5 part of the compound 201, 4.5 parts of a pigment yellow 155, and 120 parts of styrene was dissolved by an attritor (manufactured by Mitsui Mining Co., Ltd.) for 3 hours to obtain a coloring compound dispersion (1).

In a 2 L four-necked flask having a high-speed stirring device T.K. homomixer (manufactured by PRIMIX Corporation), 710 parts of ion exchange water and 450 parts of a 0.1 mol/L trisodium phosphate aqueous solution were added, the rotation speed was adjusted to 12000 rpm, and then the mixture was warmed to 60° C. To the resultant mixture, 68 parts of a 1.0 mol/L calcium chloride aqueous solution was gradually added to prepare an aqueous dispersion medium containing minute poor water-soluble dispersion stabilizer calcium phosphate.

| | |
|---|---|
| Coloring compound dispersion (1) | 133.2 parts |
| Styrene monomer | 46.0 parts |
| n-butyl acrylate monomer | 34.0 parts |
| Aluminum salicylate compound | 2.0 parts |
| (manufactured by Orient Chemical Industries | |
| Co., Ltd., BONTRON E-88) | |
| Polar resin | 10.0 parts |
| (Polycondensation of propylene oxide | |
| modified bisphenol A and isophthalic acid, | |
| Tg = 65° C., Mw = 10000, Mn = 6000) | |
| Ester wax | 25.0 parts |
| (Melting point = 70° C., Mn = 704) | |
| Divinylbenzene monomer | 0.1 part |

The substances prescribed above were warmed to 60° C., and then uniformly dissolved•dispersed at 5000 rpm using the T.K. homomixer. In the resultant mixture, 10 parts of 2,2′-azobises(2,4-dimethylvaleronitrile) which is a polymerization initiator was dissolved to prepare a polymerizable monomer composition. The polymerizable monomer composition was put in the aqueous medium, and then granulated for 15 minutes while maintaining the rotation speed of 12000 rpm. Thereafter, a stirrer was changed from the high-speed stirring device to a stirring device having a propeller stirring blade, the polymerization was continued for 5 hours at a liquid temperature of 60° C., the liquid temperature was increased to 80° C., and then the polymerization was continued for 8 hours. After the completion of the polymerization reaction, residual monomers were distilled off at 80° C. under reduced pressure, and then the resultant substance was cooled to a liquid temperature of 30° C. to thereby obtain a polymer fine particle dispersion liquid.

Next, the polymer fine particle dispersion liquid was transferred to a washing vessel, diluted hydrochloric acid was added under stirring to adjust the pH to 1.5, and then the mixture was stirred for 2 hours. Then, the resultant substance was subjected to solid-liquid separation with a filtering unit to thereby obtain polymer fine particles. The redispersion of the polymer fine particles in water and the solid-liquid separation were repeatedly performed until the compound of phosphoric acid and calcium containing calcium phosphate was sufficiently removed. Thereafter, the polymer fine particles in which the solid-liquid separation was finally achieved were sufficiently dried with a drier to thereby obtain yellow toner base particles (1).

1.00 part (Number average diameter of primary particles of 7 nm) of hydrophobized silica fine powder which was surface treated with hexamethyldisilazane, 0.15 part (Number average diameter of primary particles of 45 nm) of rutile-type titanium dioxide fine powder, and 0.50 part (Number average diameter of primary particles of 200 nm) of rutile-type titanium dioxide fine powder based on 100 parts of the obtained yellow toner base particles were dry-mixed for 5 minutes with a Henschel mixer (manufactured by NIPPON COKE & ENGINEERING. CO., LTD.) to thereby obtain a yellow toner (1).

### Examples 2 to 7, 15, and 16, Comparative Examples 1 to 3

Each toner was obtained in the same manner as in Example 1, except changing the type and the addition amount of the compounds and the type and the addition amount of the coloring agents to be used in combination as shown in Table 1.

TABLE 1

| | | | | | Color agent to be used in | |
|---|---|---|---|---|---|---|
| | | | Compound No. | | combination | |
| | Toner No. | Color | Type | Part(s) | Type | Part(s) |
| Ex. 1 | Toner (1) | Yellow | 201 | 0.5 | Pigment Yellow 155 | 4.5 |
| Ex. 2 | Toner (2) | Yellow | 201 | 1.5 | Pigment Yellow 155 | 3.5 |
| Ex. 3 | Toner (3) | Yellow | 201 | 2.5 | Pigment Yellow 155 | 2.5 |
| Ex. 4 | Toner (4) | Yellow | 202 | 0.5 | Pigment Yellow 155 | 4.5 |
| Ex. 5 | Toner (5) | Yellow | 203 | 0.5 | Pigment Yellow 155 | 4.5 |
| Ex. 6 | Toner (6) | Yellow | 204 | 0.5 | Pigment Yellow 155 | 4.5 |
| Ex. 7 | Toner (7) | Yellow | 205 | 1.0 | Pigment Yellow 180 | 4.0 |
| Ex. 15 | Toner (15) | Magenta | 208 | 0.5 | Pigment Red 122 | 4.5 |
| Ex. 16 | Toner (16) | Magenta | 420 | 1.0 | Pigment Red 122 | 4.0 |
| Comp. Ex. 1 | Toner | Yellow | Comparison | 1.0 | Pigment Yellow 155 | 4.0 |
| | (Comparative 1) | | compound (1) | | | |
| Comp. Ex. 2 | Toner | Yellow | Comparison | 0.5 | Pigment Yellow 155 | 4.5 |
| | (Comparative 2) | | compound (1) | | | |
| Comp. Ex. 3 | Toner | Yellow | Comparison | 1.0 | Pigment Yellow 180 | 4.0 |
| | (Comparative 3) | | compound (1) | | | |

### Emulsion Aggregation Method

### Example 8

82.6 parts of styrene, 9.2 parts of n-butyl acrylate, 1.3 parts of acrylic acid, 0.4 part of hexanediol acrylate, and 3.2 parts of n-lauryl mercaptan were mixed to be dissolved. An aqueous solution of 1.5 parts of NEOGEN RK (manufactured by Daiichi Kogyo Seiyaku Co., Ltd.) in 150 parts of ion exchange water was added to and dispersed in this solution. Furthermore, an aqueous solution of 0.15 part of potassium peroxodisulfate in 10 parts of ion exchange water was added while slowly stirring the resultant solution for 10 minutes. After nitrogen substitution, emulsion polymerization was carried out at 70° C. for 6 hours. After the completion of the polymerization, the reaction liquid was cooled to room temperature, and ion exchange water was added thereto to thereby obtain a resin particle dispersion liquid having a solid content concentration of 12.5% by mass and a median diameter on a volume basis of 0.2 μm.

A wax dispersion liquid was obtained by mixing 100 parts of ester wax (Melting point=70° C., Mn=704) and 15 parts of Neogen RK with 385 parts of ion exchange water, and then dispersing the resultant mixture for about 1 hour using a wet jet mill JN100 (manufactured by Jokoh Co., Ltd.). The concentration of the wax dispersion was 20% by mass.

A coloring agent dispersion liquid was obtained by mixing 15 parts of Neogen RK with 885 parts of ion exchange water using the compound 206 (20 parts) and a pigment yellow 180 (80 parts) as a coloring agent, and then dispersing the resultant mixture for about 1 hour using a wet jet mill JN100 (manufactured by Jokoh Co., Ltd.).

The median diameter on a volume basis of the color particles in the coloring agent dispersion liquid was 0.2 μm. The concentration of the dispersion liquid was 10% by mass.

160 parts of the resin particle dispersion liquid, 10 parts of the wax dispersion liquid, 10 parts of the coloring agent dispersion liquid, and 0.2 part of magnesium sulfate were dispersed using a homogenizer (manufactured by IKA: ULTRA-TURRAX T50), and then the resultant mixture was warmed to 65° C. under stirring. After stirring at 65° C. for 1 hour, it was confirmed with an optical microscope that aggregate particles having an average particle diameter of about 6.0 μm was formed. After adding 2.2 parts of Neogen RK, the resultant mixture was heated to 80° C., and then stirred for 120 minutes to obtain fused spherical toner particles. After cooling, the resultant substance was filtered, and then the filtered solid was stirred and washed with 720 parts of ion exchange water for 60 minutes. The solution containing the toner particles was filtered, and then the same washing was repeatedly performed until the electric conductivity of the filtrate reached 150 μS/cm or less. The resultant substance was dried using a vacuum dryer to thereby obtain toner base particles.

With 100 parts of the toner base particles above, 1.8 parts of hydrophobized silica fine powder having a specific surface area measured by a BET method of 200 m²/g was dry-mixed with a Henschel mixer (manufactured by Mitsui Mining Co., Ltd.) to obtain a yellow color toner (8). Examples 9, 10, 17, and 18, Comparative Example 4

Each toner was obtained in the same manner as in Example 8, except changing the type and the addition amount of the compounds and the type and the addition amount of the coloring agents to be used in combination as shown in Table 2.

Neopen magenta 525 (manufactured by BASF A.G.) used in Comparative Example 4 has the following structure.

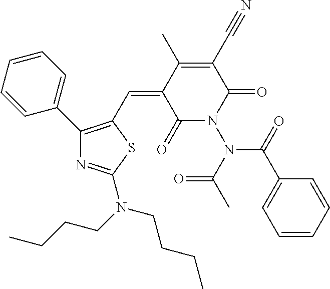 [SMILES: CCCCN(CCCC)c1nc(-c2ccccc2)c(/C=C2\C(=O)N(N(C(C)=O)C(=O)c3ccccc3)C(=O)C(C#N)=C2C)s1]

TABLE 2

| | | | | | Color agent to be used in | |
|---|---|---|---|---|---|---|
| | | | Compound No. | | combination | |
| | Toner No. | Color | Type | Part(s) | Type | Part(s) |
| Ex. 8 | Toner (8) | Yellow | 206 | 20 | Pigment Yellow 180 | 80 |
| Ex. 9 | Toner (9) | Yellow | 207 | 20 | Pigment Yellow 180 | 80 |
| Ex. 10 | Toner (10) | Yellow | 201 | 20 | Pigment Yellow 74 | 80 |
| Ex. 17 | Toner (17) | Magenta | 210 | 20 | Pigment Red 122 | 80 |
| Ex. 18 | Toner (18) | Magenta | 208 | 2 | Pigment Red 150 | 98 |
| Comp. Ex. 4 | Toner | Magenta | Neopen | 20 | Pigment Red 150 | 80 |
| | (Comp. Ex. 4) | | magenta 525 | | | |

### Pulverization Method

### Example 11

| | |
|---|---|
| Binding resin (Polyester resin) | 100.0 parts |
| (Tg 55° C., Acid value 20 mgKOH/g, | |
| Hydroxyl value 16 mgKOH/g, Molecular | |
| weight: Mp 4500, Mn 2300, Mw 38000) | |
| Compound 202 | 1.0 part |
| Pigment yellow 185 | 4.0 parts |
| 1,4-di-t-butylsalicylic acid aluminum compound | 0.5 part |
| Paraffin wax (Melting point of 78° C.) | 5.0 parts |

The substances prescribed above were sufficiently mixed with a Henschel mixer (FM-75J type, Mitsui Mining Co., Ltd.), and then kneaded at a feed amount of 60 kg/hr with a biaxial kneader (PCM-45, manufactured by Ikegai Corporation) set to a temperature of 130° C. (in which the temperature of a kneaded product when discharged was about 150° C.). The obtained kneaded product was cooled, roughly crushed with a hammer mill, and then pulverized at a feed amount of 20 kg/hr with a mechanical pulverizer (T-250: manufactured by Turbo Kogyo Co., Ltd.).

Furthermore, the obtained toner pulverized product was classified using a multi-division classifier utilizing the Coanda effect to thereby obtain toner base particles.

100 parts of the toner base particles above were dry-mixed with 1.8 parts of hydrophobized silica fine powder having a specific surface area, measured by a BET method, of 200 m2/g with a Henschel mixer (manufactured by Mitsui Mining Co., Ltd.) to thereby obtain a yellow color toner (11).

### Examples 12 to 14 and 19 to 21, Comparative Examples 5 to 7

Each toner was obtained in the same manner as in Example 11, except changing the type and the addition amount of the compounds and the type and the addition amount of the coloring agents to be used in combination as shown in Table 3.

TABLE 3

| | | | | | Color agent to be used in | |
|---|---|---|---|---|---|---|
| | | | Compound No. | | combination | |
| | Toner No. | Color | Type | Part(s) | Type | Part(s) |
| Ex. 11 | Toner (11) | Yellow | 202 | 1.0 | Pigment Yellow 185 | 4.0 |
| Ex. 12 | Toner (12) | Yellow | 203 | 2.5 | Pigment Yellow 185 | 2.5 |
| Ex. 13 | Toner (13) | Yellow | 203 | 1.0 | Solvent Yellow 162 | 4.0 |
| Ex. 14 | Toner (14) | Yellow | 203 | 2.5 | Solvent Yellow 162 | 2.5 |
| Ex. 19 | Toner (19) | Magenta | 420 | 1.0 | Pigment Red 150 | 4.0 |
| Ex. 20 | Toner (20) | Magenta | 420 | 1.0 | Pigment Red 57:1 | 4.0 |
| Ex. 21 | Toner (21) | Magenta | 808 | 1.0 | Pigment Red 122 | 4.0 |
| Comp. Ex. 5 | Toner | Magenta | Neopen | 1.0 | Pigment Red 122 | 4.0 |
| | (Comparative 5) | | magenta 525 | | | |
| Comp. Ex. 6 | Toner | Magenta | Solvent Red 49 | 2.5 | Pigment Red 122 | 2.5 |
| | (Comparative 6) | | | | | |
| Comp. Ex. 7 | Toner | Magenta | Solvent Red 49 | 1.0 | Pigment Red 57:1 | 4.0 |
| | (Comparative 7) | | | | | |

### Image Sample Evaluation

Using the toners (1) to (21) and the toners (Comparative Example 1) to (Comparative Example 7), image samples were output, and then the image characteristics described later were compared to be evaluated. For the comparison of the image characteristics, an LBP-5300 (manufactured by CANON KABUSHIKI KAISHA) (hereinafter abbreviated as “LBP”) was used as an image forming apparatus.

In the evaluation, a CRG in which each toner was individually charged was prepared for each evaluation item. Then, each CRG charged with each toner was set in the LBP, and then the evaluation was performed for each evaluation item described below. As a base paper of the image sample, a CLC color copy paper (manufactured by CANON KABUSHIKI KAISHA) was used.

### Creation of Reference Toner

In order to perform the following evaluation, reference toners containing a coloring material alone were created as follows. A description is given taking the reference toner used for the evaluation of the toner manufactured in Example 1 as an example.

A reference toner 1 was manufactured in the same manner as in Example 1, except using 5.0 parts of the compound 201 in place of “0.5 part of the compound 201 and 4.5 parts of the pigment yellow 155”. A reference toner 2 was manufactured in the same manner as in Example 1, except using 5.0 parts of the pigment yellow 155 in place of “0.5 part of the compound 201 and 4.5 parts of the pigment yellow 155”.

Thus, two kinds of reference toners containing either one of the two kinds of coloring agents, which were contained in the toner of each of Examples/Comparative Examples, alone were manufactured for each toner. In the manufacturing, the coloring agent amount in each reference toner was the total amount of the two kinds of coloring agents contained in the toners of Examples/Comparative Examples.

### Color Gamut Measurement

For image samples created using the toners created in Examples and the reference toner corresponding to each toner, a spectrophotometric colorimeter manufactured by Konica Minolta Co., Ltd., “CM-2600d” was used. The measurement was performed under the following measurement conditions.

Colorimetry diameter 3 mm

Visual field 2°

UV cut mode Regular reflected light treatment mode SCE

Standard light source D₅₀

Using the apparatus, the chromaticity (L*, a*, b*) in the L*a*b* color system was measured. The color saturation (C*) was calculated by the following expression based on the measurement values of the color characteristics.

C*=((a*)²+(b*)²)^{1/2}

Next, “ΔE” shown in Table 4 is described.

C*, L* of the image samples created using the two kinds of reference toners are plotted on the C*L* plane, and then the two points are connected by a straight line. In this line segment, an interpolation point based on the ratio of the content of the coloring agent in the toner to be evaluated is specified, and then the C*, L* at the point are defined as (C₀*, L₀*). For example, in the toner of Example 1, since the ratio (on a mass basis) of the compound 201 to the pigment yellow 155 is 1:9, the dividing point which divides the line segment into 1:9 with the point on the side of the reference toner containing the compound 201 alone as the starting point is the interpolation point.

Then, when the point on the C*L* plane of the toner manufactured in each of Examples is (C*, L*), the color shift amount ΔE is represented by the following expression.

ΔE=(C*−C₀*)²+(L*−L₀*)²)^{1/2}

When the ΔE is larger, larger color degree changes can be obtained when coloring compounds were mixed.

The evaluation (color change) was performed according to the following criteria.

A: ΔE is 15.0 or more.
B: ΔE is 7.0 or more and less than 15.0.
C: ΔE is less than 7.0.

TABLE 4

| | | | | Another | | Color shift | |
|---|---|---|---|---|---|---|---|
| | | | Dye compound | coloring | | amount | Color |
| | | Color | No. | agent | Toner | ΔE | change |
| Examples | 1 | Y | 201 | PY155 | Suspension | 27.2 | A |
| | | | | | polymerization | | |
| | | | | | method | | |
| | 2 | Y | 201 | PY155 | Suspension | 16.4 | A |
| | | | | | polymerization | | |
| | | | | | method | | |
| | 3 | Y | 201 | PY155 | Suspension | 14.5 | B |
| | | | | | polymerization | | |
| | | | | | method | | |
| | 4 | Y | 202 | PY155 | Suspension | 25.6 | A |
| | | | | | polymerization | | |
| | | | | | method | | |
| | 5 | Y | 203 | PY155 | Suspension | 25.2 | A |
| | | | | | polymerization | | |
| | | | | | method | | |
| | 6 | Y | 204 | PY155 | Suspension | 20.5 | A |
| | | | | | polymerization | | |
| | | | | | method | | |
| | 7 | Y | 205 | PY190 | Suspension | 24.3 | A |
| | | | | | polymerization | | |
| | | | | | method | | |
| | 8 | Y | 206 | PY190 | Emulsion | 18.5 | A |
| | | | | | aggregation method | | |
| | 9 | Y | 207 | PY190 | Emulsion | 17.0 | A |
| | | | | | aggregation method | | |
| | 10 | Y | 201 | PY74 | Emulsion | 18.5 | A |
| | | | | | aggregation method | | |
| | 11 | Y | 202 | PY185 | Pulverization method | 22.6 | A |
| | 12 | Y | 203 | PY185 | Pulverization method | 19.2 | A |
| | 13 | Y | 203 | SY162 | Pulverization method | 12.4 | B |
| | 14 | Y | 203 | SY162 | Pulverization method | 10.8 | B |
| | 15 | Y | 208 | PR122 | Suspension | 15.2 | B |
| | | | | | polymerization | | |
| | | | | | method | | |
| | 16 | M | 420 | PR122 | Suspension | 9.2 | B |
| | | | | | polymerization | | |
| | | | | | method | | |
| | 17 | M | 210 | PR122 | Emulsion | 10.2 | B |
| | | | | | aggregation method | | |
| | 18 | M | 208 | PR150 | Emulsion | 10.6 | B |
| | | | | | aggregation method | | |
| | 19 | M | 420 | PR150 | Pulverization method | 11.6 | B |
| | 20 | M | 420 | PR57:1 | Pulverization method | 9.7 | B |
| | 21 | M | 808 | PR122 | Pulverization method | 7.6 | B |
| Comparative | Comp. | Y | Comparison | PR155 | Suspension | 3.1 | C |
| Examples | Ex. 1 | | Compound (1) | | polymerization | | |
| | | | | | method | | |
| | Comp. | Y | Comparison | PR155 | Suspension | 3.1 | C |
| | Ex. 2 | | Compound (1) | | polymerization | | |
| | | | | | method | | |
| | Comp. | Y | Comparison | PR180 | Suspension | 3.4 | C |
| | Ex. 3 | | Compound (1) | | polymerization | | |
| | | | | | method | | |
| | Comp. | M | NM525 | PR150 | Emulsion | 2.3 | C |
| | Ex. 4 | | | | aggregation method | | |
| | Comp. | M | NM525 | PR122 | Pulverization method | 1.8 | C |
| | Ex. 5 | | | | | | |
| | Comp. | M | SR49 | PR122 | Pulverization method | 2.5 | C |
| | Ex. 6 | | | | | | |
| | Comp. | M | SR49 | PR57:1 | Pulverization method | 4.6 | C |
| | Ex. 7 | | | | | | |

As is clear from the evaluation results of the toners by the polymerization method, the toners by the emulsion aggregation method, and the toners by the pulverization method shown in Table 1, larger color changes are observed in each toner by the present invention as compared with the corresponding comparative toner. More specifically, in the case of the toner containing the compound represented by General Formula (1) or General Formula (2) and a former coloring agent in combination, the color shift amount ΔE serving as the index of color shift becomes larger.

Among Examples above, an example containing the compound represented by General Formula (2) is Example 21 and other examples are examples containing the compound represented by General Formula (1). The obtained results show that a color gamut improvement effect is higher in the compound represented by General Formula (1). Examples 22 to 25, Comparative Examples 8 and 9

Toners A to D were obtained in the same manner as in Example 1, except changing the type and the addition amount of the compounds and the type and the addition amount of the coloring agents to be used in combination as shown in Table 5.

TABLE 5

| | | | | Color agent to be | |
|---|---|---|---|---|---|
| | | Compound No. | | used in combination | |
| Toner No. | Color | Type | Part(s) | Type | Part(s) |
| Toner A | Yellow | 201 | 2.0 | — | — |
| Toner B | Yellow | 203 | 2.0 | — | — |
| Toner C | Yellow | — | — | Pigment | 5.0 |
| | | | | Yellow 155 | |
| Toner D | Yellow | Comparison | 2.0 | — | — |
| | | compound (1) | | | |

Next, a mixed toner to be used for each of Examples/Comparative Examples was created as follows.

### Example 22

The toner A and the toner C were mixed at a ratio (mass ratio) of 1:4.

### Example 23

The toner A and the toner C were mixed at a ratio (mass ratio) of 2:3.

### Example 24

The toner B and the toner C were mixed at a ratio (mass ratio) of 1:4.

### Example 25

The toner B and the toner C were mixed at a ratio (mass ratio) of 2:3.

### Comparative Example 8

The toner D and the toner C were mixed at a ratio (mass ratio) of 1:4.

### Comparative Example 9

The toner D and the toner C were mixed at a ratio (mass ratio) of 2:3.

The same evaluation as that of Example 1 was performed using the mixed toners above. The evaluation results are shown in Table 6.

An interpolation point for calculating the ΔE was specified as follows.

C*, L* of image samples created using two kinds of toners before mixing are plotted on the C*L* plane, and then the two points are connected by a straight line. In this line segment, an interpolation point based on the mixing ratio in the mixed toner to be evaluated is specified, and then C*, L* at the point are (C₀*, L₀*). For example, in the toner of Example 22, since the ratio (on a mass basis) of the toner A to the toner C is 1:4, the dividing point of dividing the line segment into 1:4 with the point on the side of the toner A as the starting point is the interpolation point.

TABLE 6

| | | Color shift | |
|---|---|---|---|
| | | amount | Color |
| | Mixing ratio | ΔE | change |
| Ex. 22 | Toner A/Toner C = 1/4 | 25.3 | A |
| Ex. 23 | Toner A/Toner C = 2/3 | 17.0 | A |
| Ex. 24 | Toner B/Toner C = 1/4 | 23.2 | B |
| Ex. 25 | Toner B/Toner C = 2/3 | 14.3 | A |
| Comp. Ex. 8 | Toner D/Toner C = 1/4 | 2.9 | C |
| Comp. Ex. 9 | Toner D/Toner C = 2/3 | 3.5 | C |

### Examples 26 and 27, Comparative Example 10

The toners A to D were individually introduced into different cartridges, and then images were formed on the same place on paper using the cartridges in such a manner that the toner application amount was as shown in Table 6. The same evaluation as that of Example 1 was performed using the obtained images. The evaluation results are shown in Table 7.

An interpolation point for calculating the ΔE was specified as follows.

C*, L* of image samples created using two kinds of toners are plotted on the C*L* plane, and then the two points are connected by a straight line. In this line segment, an interpolation point based on the toner application amount of each toner on each image is specified, and then C*, L* at the point are (C₀*, L₀*). For example, in the toner of Example 26, since the toner application amount ratio (on a mass basis) of the toner A to the toner C is 1:4, the dividing point of dividing the line segment into 1:4 with the point on the side of the toner A as the starting point is the interpolation point.

TABLE 7

| | | Color | |
|---|---|---|---|
| | | shift | |
| | | amount | Color |
| | Application amount ratio | ΔE | change |
| Ex. 26 | Toner A/Toner C = 1/4 | 22.5 | A |
| Ex. 27 | Toner B/Toner C = 1/4 | 19.2 | A |
| Comp. Ex. 10 | Toner D/Toner C = 1/4 | 2.7 | C |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-118574, filed Jun. 11, 2015 which is hereby incorporated by reference herein in its entirety.

What is claimed is:

1. A toner comprising:
a binding resin; and
a coloring agent, wherein
the coloring agent contains at least one compound selected from the group consisting of a compound represented by General Formula (1) and a compound represented by General Formula (2), 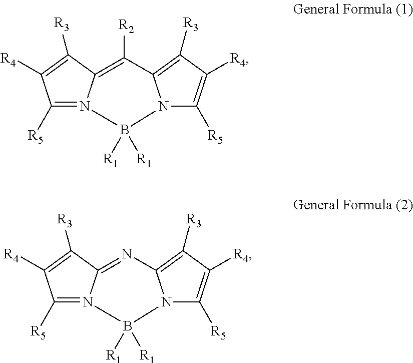
wherein,
R₁ represents a halogen atom, an alkyl group, an alkynyl group, an alkoxy group, an aryl group, or a phenoxy group, or represents an atomic group necessary for forming a ring structure by bonding with adjacent R₅,
R₂ represents a hydrogen atom, a halogen atom, a cyano group, an alkyl group, an aryl group, a phenoxy group, a thiophenoxy group, an alkynyl group, or an amino group,
R₃ represents a hydrogen atom, an alkyl group, or an aryl group, or represents an atomic group necessary for forming a ring structure by bonding with adjacent R₄,
R₄ represents a hydrogen atom, an alkyl group, an aryl group, an alkyl acrylate group, or a sulfone group, or represents an atomic group necessary for forming a ring structure by bonding with adjacent R₃ or R₅, and
R₅ represents a hydrogen atom, an alkyl group, an aryl group, or an alkynyl group, or represents an atomic group necessary for forming a ring structure by bonding with adjacent R₁ or R₄.

2. The toner according to claim 1, wherein R₁ is a fluorine atom.

3. The toner according to claim 1, wherein
the coloring agent contains another color pigment in addition to the at least one compound selected from the group consisting of the compound represented by General Formula (1) and the compound represented by General Formula (2).

4. The toner according to claim 3, wherein
the color pigment is a pigment selected from the group consisting of C.I. Pigment Yellow 74, C.I. Pigment Yellow 155, C.I. Pigment Yellow 180, C.I. Pigment Yellow 185, C.I. Pigment Red 122, C.I. Pigment Red 150, and C.I. Pigment Red 57:1.

5. The toner according to claim 1, wherein
the coloring agent contains the compound represented by General Formula (1).
